(19) United States
(12) Patent Application Publication
(10) Pub. No.: US 2017/0206602 A1
(43) Pub. Date: Jul. 20, 2017

(54) Strategy Server

(71) Applicant: TD Ameritrade IP Company, Inc., Omaha, NE (US)

(72) Inventors: Enrique Sallent, Passaic, NJ (US); William Hanlon, Tarrytown, NY (US); Gunjan Ghodawat, Bayonne, NJ (US); Victor Jones, Singapore (SG); Harrison W. Napper, Chicago, IL (US)

(73) Assignee: TD Ameritrade IP Company, Inc., Omaha, NE (US)

(21) Appl. No.: 15/002,082

(22) Filed: Jan. 20, 2016

(51) Int. Cl. G06Q 40/04; G06F 3/0484; G06F 3/0482; G06F 17/30

(52) U.S. Cl. CPC G06Q 40/04; G06F 17/30867; G06F 3/04842; G06F 3/0482

(57) ABSTRACT

Disclosed herein are system and method embodiments for generating a strategy. An embodiment operates by receiving one or more inputs indicating criteria for a strategy, including a predicted direction for the stock, a predicted duration for the direction, a tolerable probability of success, and a tolerable percentage of monetary loss from an account. One or more instruments associated with the stock are retrieved from the database configured for mass storage of real-time quotes and trading data. A strategy list containing one or more strategies is generated from the one or more instruments, where the one or more strategies are compliant with the criteria.

### BACKGROUND

When trading financial instruments the average investor may be asked to make costly decisions based on variables they do not understand, described in terms of financial jargon, complex models, or other concepts that are not intuitive or accessible to the investor. Without having access to the tools in addition to real-time market data for analyzing the markets, trading may be a costly process of trial and error.

### BRIEF DESCRIPTION OF THE DRAWINGS

The accompanying drawings are incorporated herein and form a part of the specification.

FIG. 1 is a block diagram of example system architecture, according to an embodiment.

FIG. 2 is a block diagram of a trading platform environment, according to an embodiment.

FIGS. 3A-E, 4A-D, 5A-C, 6A-C, 7A-C, 8A-C and 9 are diagrams of a user interface, according to an embodiment.

FIG. 10 is a block diagram of a strategy generator, according to an embodiment.

FIG. 11 is a flowchart of a method for displaying a strategy and a strategy list, according to an embodiment.

FIG. 12 is a flowchart of a method for generating a strategy and a strategy list, according to an embodiment.

FIG. 13 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

An option is a financial instrument that is contract giving its owner the right, but not an obligation, to buy or sell an underlying asset or instrument at a strike price on, or before, a specific date. As a result, the seller of an option incurs an obligation to fulfill the transaction if the holder decides to exercise the option prior to its expiration. Distinct from the concept of options trading are the tools for analyzing and/or executing trades. Because of the amount and complexity of financial information generated by large-scale, dynamic processing and computational analysis of market data, e.g., using probabilistic models, statistical models, etc., combined with a need to make split second decisions, tools for analyzing and/or executing trades and real-time market data must be able to do in real-time what a person cannot: monitor, store, process, transform, and/or display correct outputs that reflect the modeling of potentially hundreds of variables which are in turn calculated, sorted, filtered, and/or displayed on the fly.

Further, because trading systems are technology dependent and split second delay in making a trade may cause monetary loss, investors now depend on real-time market data and complicated real-time analysis of same being generated in seconds or milliseconds. The analysis of real-time market data facilities investors in making split-second decisions for trading or abstaining from trading a financial instrument. Because, due to the technological nature of trading, the real-time data reflects changes in prices that occur in seconds and milliseconds, and the real-time analysis of market data must be provided at speeds that allow investors to act on market data in real-time time, rather than on stale market data.

In this context, system, method and/or computer program product embodiments, and/or combinations and sub-combinations thereof, are provided herein for generating a financial instrument, such as a strategy. The strategy is generated using real-time data and is provided to a trading system for display and potential execution in the amount of time that the investor can trade the strategy using real-time data and profit from the strategy.

A financial instrument, such as an option, stock, etc., when executed, causes an exchange of money and/or assets between multiple parties. Example embodiments provide a trading platform configured to transform and/or filter dynamic market data provided and/or derived from, for example, market data sources. The trading platform also generates financial instruments by combining the market data and predefined templates for different trading instruments, with criteria input provided by a user. In an example, a combination of inputs provided by the user is transformed into a set of criteria used to generate one or more options strategies. Of the strategies determined to meet the criteria, variables associated with applying each eligible option strategy may be dynamically processed to calculate probability of success and measure of return for different types of strategies. A user interface may be provided to receive initial criteria as well as to display processed output in a manner that provides context, for example, to aid in the user's trade decision-making process. A user interface may also receive input which facilitates a user to trade on one or more of the displayed strategies. One of skill in the relevant art(s) will appreciate that system, method and/or computer program product embodiments described herein, while described in terms of options trading, may be readily adapted to stocks, futures, and/or other types of financial instruments.

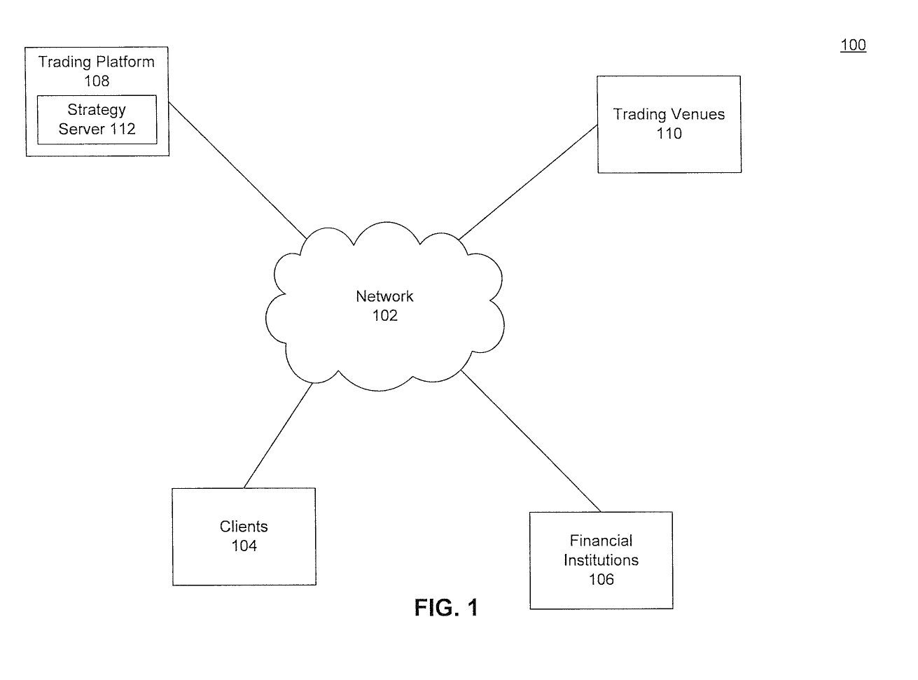

FIG. 1 shows example system architecture 100, according to an embodiment. System architecture 100 includes a network 102 that connects one or more clients 104 and one or more financial institutions 106 to a trading platform 108.

Network 102 may include one or more networks of one or more network types, including any combination of local area network (LAN), wide area network (WAN) such as the Internet, etc. To carry data communication, network 102 uses numerous protocols, such as an internet protocol (“IP), file transfer protocol (“FTP”), transmission control protocol (“TCP”), and HyperText Transfer Protocol (“HTTP”), to give a few examples. Further, intermediate web servers, gateways, or other servers may be provided between components of the system shown in FIG. 1, depending upon a particular application or environment. Network 102 may encompass connections between any or all components in system architecture 100, including connections between and within clients 104, financial institutions 106, trading platform 108, and trading venues 110.

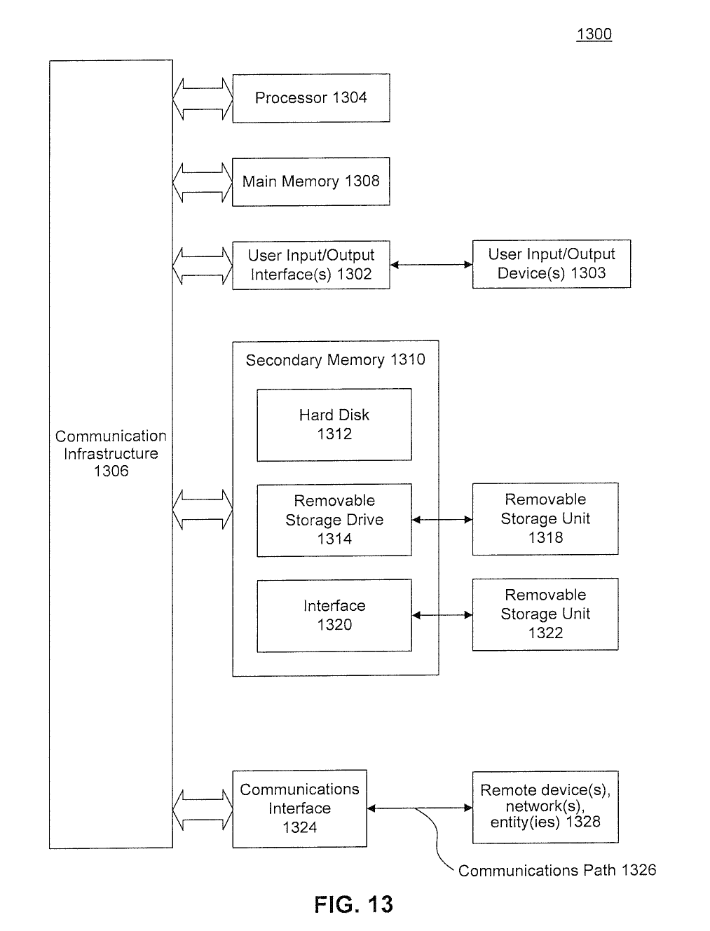

In an example embodiment, client 104 includes a computer, device, interface, etc. or any sub-system thereof. Client 104 includes but is not limited to a personal computer, mobile device, smart device, tablet, television, or other computing device. Client 104 may include an operating system (OS), applications installed to perform various functions such as, for example, browsing and/or navigation of data made accessible locally, in memory, and/or over network 102. Client 104 may include a web browser. A browser may display information, support web-applications, operate services, and/or process inputs received by client 104 from user interaction with various components of client 104. Client 104 may include one or more native applications that may operate independently of a browser to receive and/or transmit data over network 102. Client 104 may have some or all components of an example computing device included in FIG. 13.

By way of example, client 104 may download one or more applications to the mobile operating system of client 104 to orchestrate and/or manage access to network 102 such that data, e.g., from financial institutions 106 and trading venues 110, may be obtained in real-time, routinely, upon a request or input by a user, and/or when a notification is received to collect updated data.

In an example embodiment, financial institutions 106 include one or more public or private institutions that collect, manage, and/or store funds, for example, in accounts containing funds. Financial institutions 106 may participate directly or indirectly in the investment of financial assets. Financial institutions 106 may host and/or provide access to data about accounts including, but not limited to, an amount of available funds, account balances, credit, buying power, account value etc. Financial institutions 106 may manage one or more databases containing financial information regarding their customers, which may include one or more users of trading platform 108. Moreover, a user operating client 104 may interact with one or more financial institutions 106 over network 102 to manage an account and/or investment. A client 104 may interact with financial institutions 106 by interacting with trading platform 108. For example, while interacting with trading platform 108 a user of client 104 may access, change, and/or manage account related data controlled by financial institutions 106. A person having skill in the relevant art(s) would understand that methods and standards for securing financial data are known and can be implemented using various information security techniques and policies, e.g., username/password, Transport Layer Security (TLS), Secure Sockets Layer (SSL), and/or other cryptographic protocols providing communication security.

To manage and/or invest assets held in an account, such as financial instruments, financial institutions 106, clients 104 and trading platform 108 communicate with one or more trading venues 110. Example trading venues 110 include stock exchanges, such as, New York Stock Exchange (“NYSE”), National Association of Securities Dealers Automated Quotations (“NASDAQ”), American Stock Exchange (“AMEX”), Chicago Board Options Exchange (“CBOE”), Boston Stock Exchange (“BSE”), National Stock Exchange (“NSX”), Tokyo Stock Exchange, Euronext, London Stock Exchange (“LSE”), etc., and electronic communication networks (ECNs). Trading venues 110 may disseminate any data related to financial markets. Data related to financial markets (collectively referred to as market data) includes but is not limited to quotes, trades, prices, and financial instrument details based, for example, on end-of-day, intra-day, real-time market data. One of skill in the relevant art(s) would understand that sources of market data may be made available remotely and/or by services that track financial data across markets, asset classes, and financial instruments (e.g., equities, derivatives, commodities, fixed income, and foreign exchange). Moreover, such sources may provide data in various forms, types, reporting methods, terms, benchmarks, standard data points (e.g., quotes, prices, fundamentals, earnings estimates, analyst ratings, statistics, etc.).

In an embodiment, system architecture 100 operates as a service-oriented architecture and uses a client-server model that would be understood by one of skill in the relevant art(s) to enable various forms of interaction and communication between clients 104, trading platform 108, financial institutions 106 and/or trading venues 110. For example, trading platform 108 may be implemented on a server that stores, processes, and manipulates data received from clients 104 and financial institutions 106, and also generates the financial instruments that are displayed, processed and/or traded on trading venues 110. In a further embodiment, trading platform 108 includes computing components described in detail in FIG. 13.

In an embodiment, trading platform 108 includes a strategy server 112. Strategy server 112 generates one or more strategies based on selection criteria provided by client device 104 and the market data, such as binary chained options, provided by trading venues 110. Once generated, strategy server 112 transmits the one or more strategies for display and potential trading on client 104.

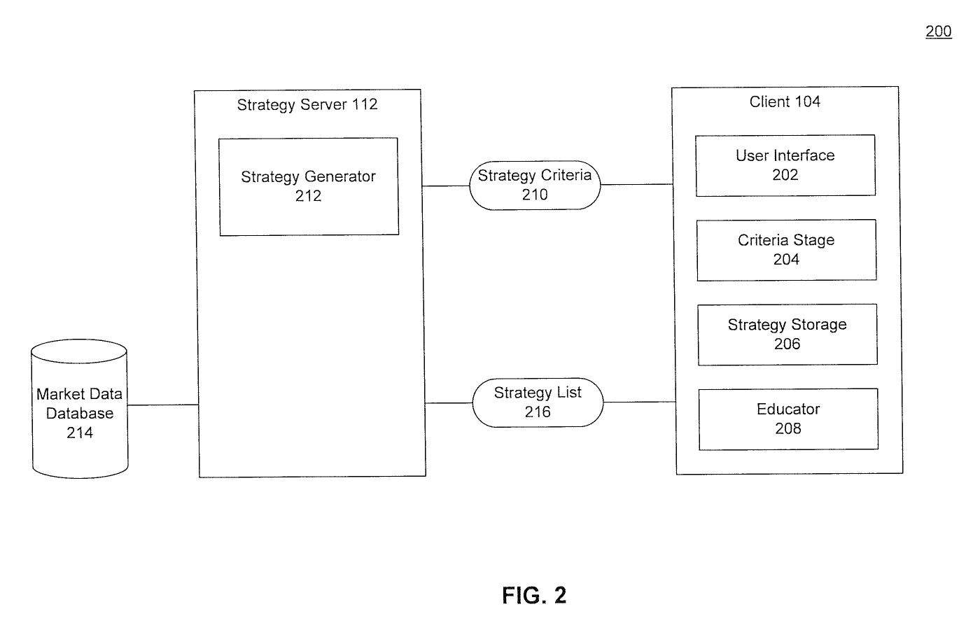

FIG. 2 is a block diagram 200 of a trading platform environment, according to an embodiment. In an embodiment, client 104 includes a user interface 202. User interface 202 includes one or more displays that display data provided by trading platform 108 and also includes one or more displays, buttons, drop down menus, graphical interfaces, etc., that collects data from the user using client 104. For example, user interface 202 displays market data generated by trading venues 110 and provided via trading platform 108 to client 104, information regarding various trading accounts, and graphical inputs for selection criteria for generating financial instruments.

In an embodiment, client 104 includes a criteria storage 204. Criteria storage 204 stores the criteria provided to user interface 202 by user input. In an embodiment, criteria storage also stores different attributes associated with the one or more criteria that are presented for selection to the user via user interface 202. Criteria storage 204 may be a volatile or non-volatile memory discussed in detail in FIG. 13.

In an embodiment, client 104 includes a strategy storage 206. Strategy storage 206 stores one or more strategies, (but can also store other financial instruments) generated using strategy server 112 in response to the criteria selected by the user. Strategy storage 206 may be a volatile or non-volatile memory discussed in detail in FIG. 13.

In a further embodiment, client 104 includes an educator 208. Educator 208 may include, for example, one or more links which, when selected, may display additional explanation of the output measure and/or underlying variables. Educator 208 may comprise storage, such as a database, which stores educational material, including video clips, and/or other resources for associating elements displayed on user interface 202 with terms, keywords, and/or concepts. Educator 208 may also provide information directing users to guidance and/or customer support.

In an embodiment, user interface 202 provides a user with selection criteria for generating one or more strategies. Based on user input, the selected criteria may be stored in financial instrument storage 206 and transmitted to strategy server 112 as strategy criteria 210. Although the examples below describe the selection of strategy criteria 210 for generating strategies used in option trading, the implementation is not limited to this embodiment.

Strategy server 112 includes strategy generator 212. Strategy generator 212 generates strategy list 216 using strategy criteria 210 received from client 104 and market data made available in real-time by one or more trading venues 110.

In an embodiment, market data may be stored in market data database 214. For example, when trading platform 108 receives market data from trading venues 110, trading platform 108 parses and stores the market data in one or more market databases 214. Market data database 214 is configured for storage of gigabytes of real-time data and for fast retrieval of all or a subset of the market data upon request. Clients 104 and financial institutions 106 use trading platform 108 to access and analyze the market data, and access trading venues 110 to invest assets based on the analysis. In an alternative embodiment, other types of memory storage configured to store and provide large quantities of real-time data may be used.

Strategy generator 212 retrieves market data from market data database 214 using a database interface. For example, strategy generator 212 may generate a query including one or more criteria from the strategy criteria 210, where market data database 214 uses a query to select and retrieve market data compatible with the criteria. Strategy generator 212 then generates a strategy list 216 that is compatible with strategy criteria 210 and transmits strategy list 216 for display using user interface 202. In an embodiment, strategy list 216 includes one or more strategies. A strategy is a financial instrument or includes one or more financial instruments, and is common, but not limited to, options trading. Further, different types of strategies may be optimal for trading under different market conditions and may minimize and/or limit financial loss.

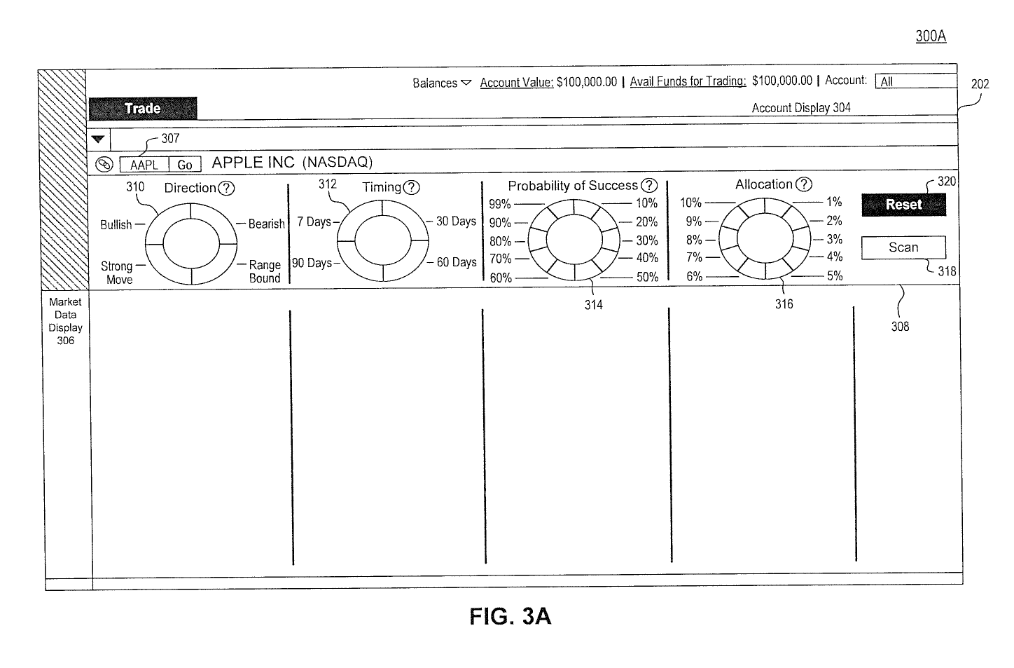

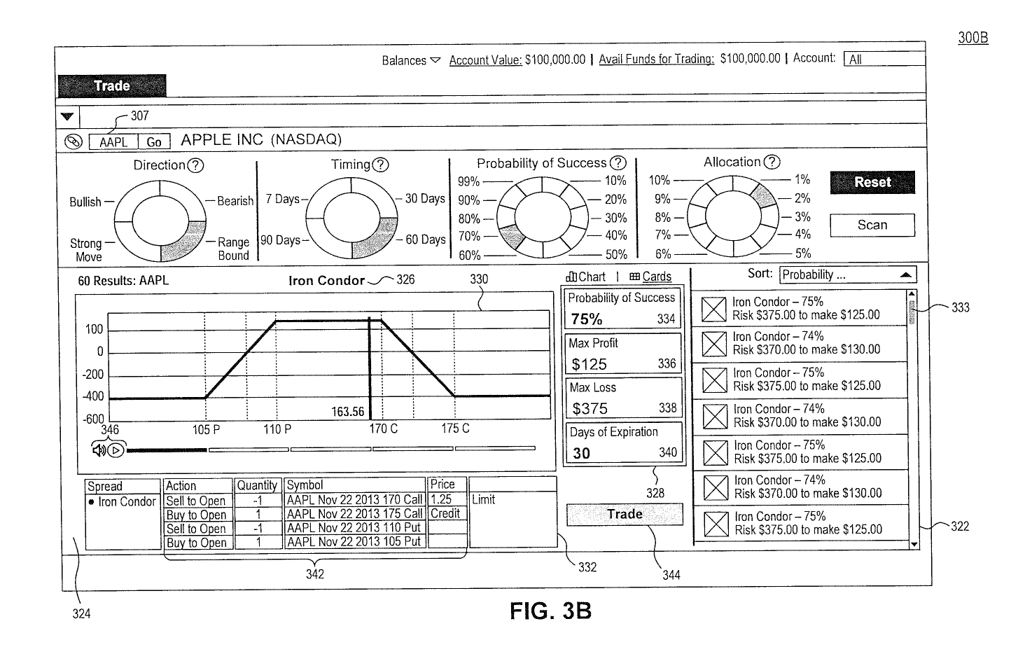

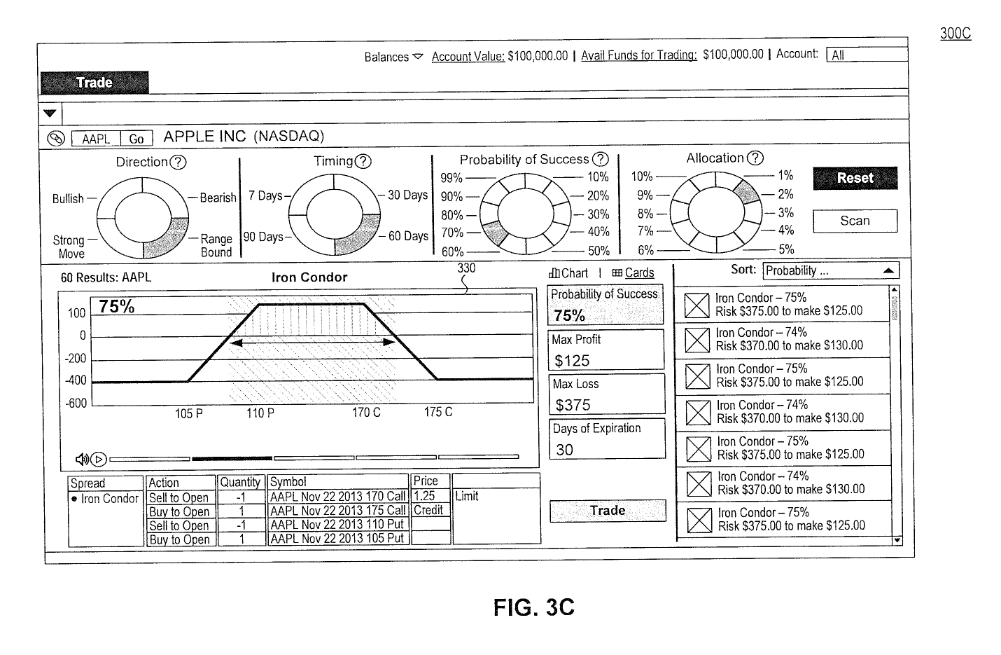

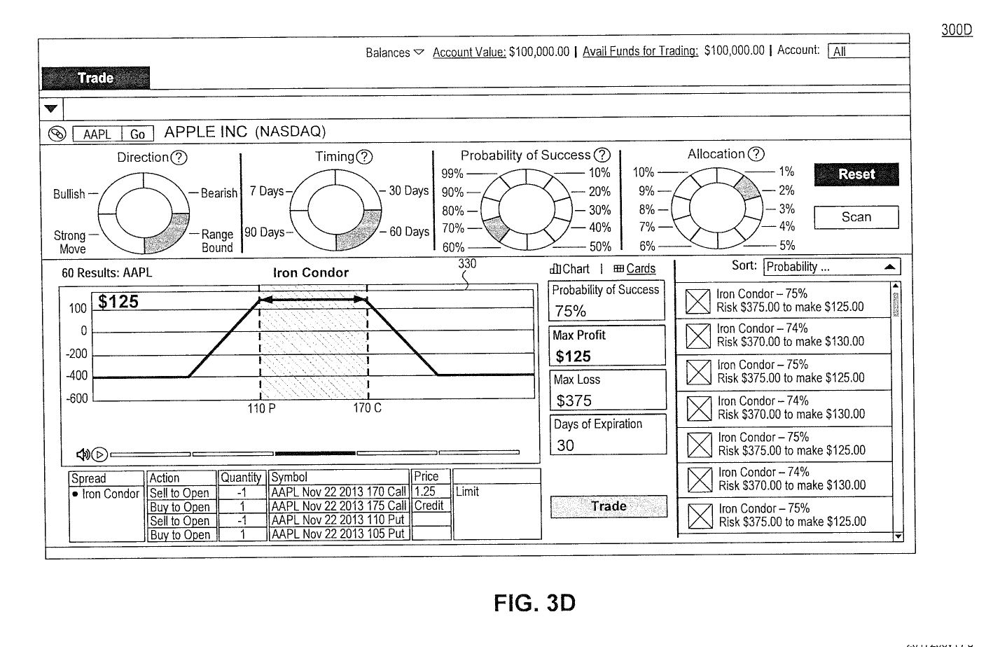

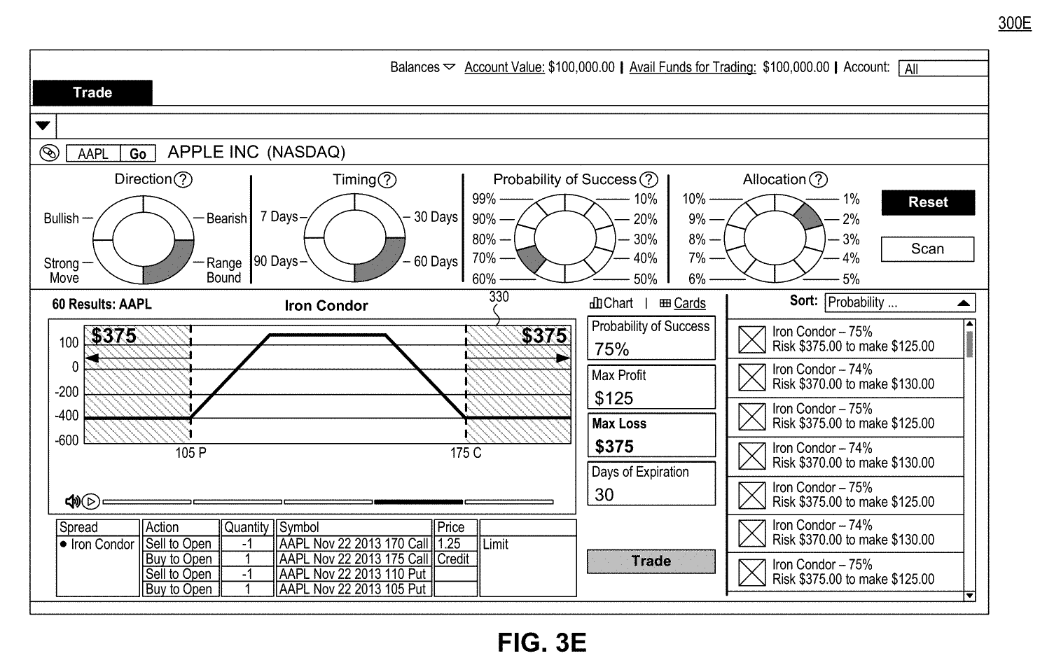

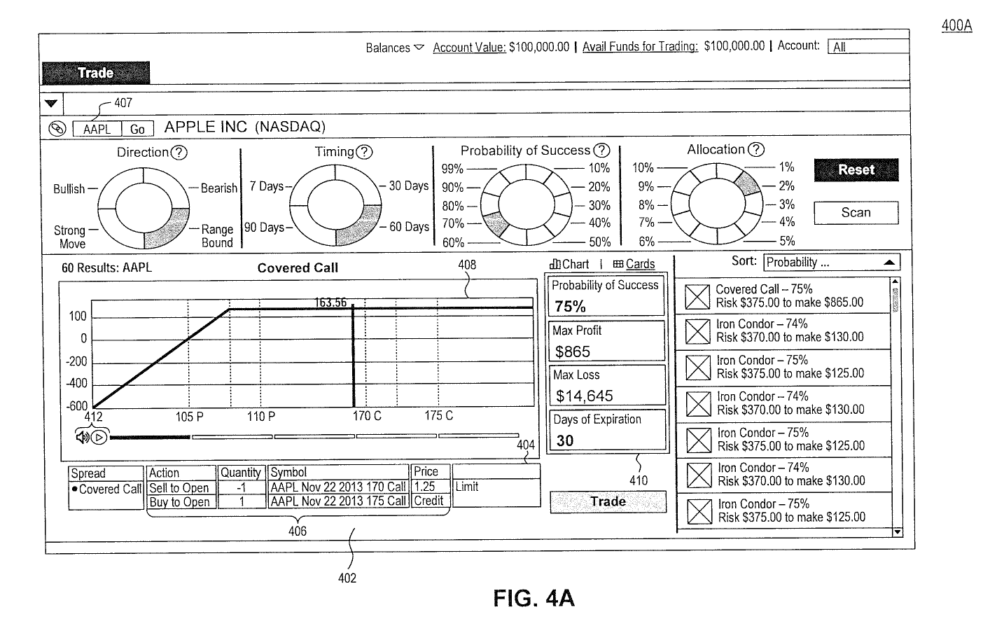

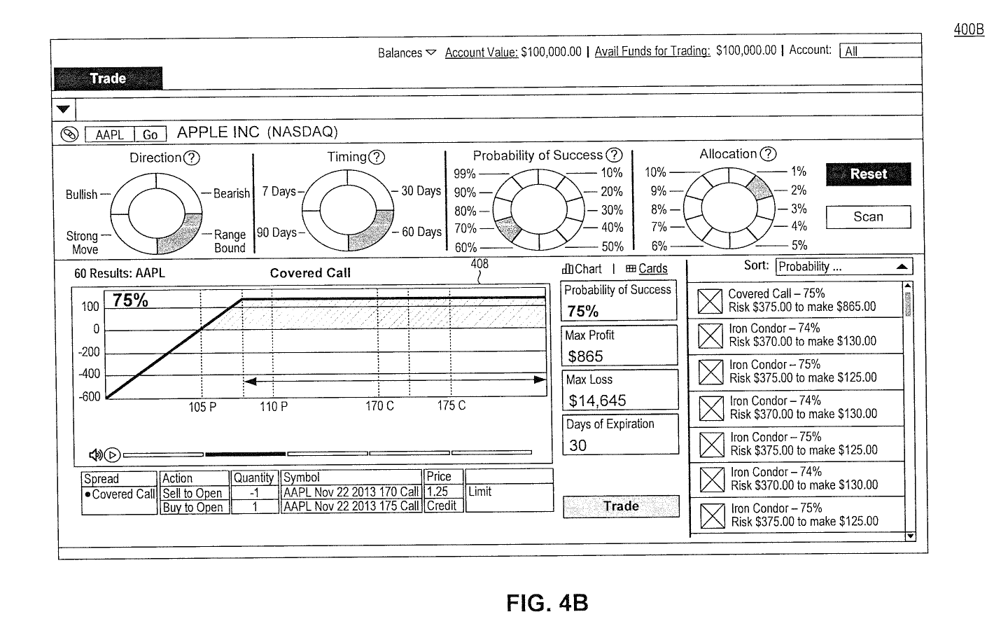

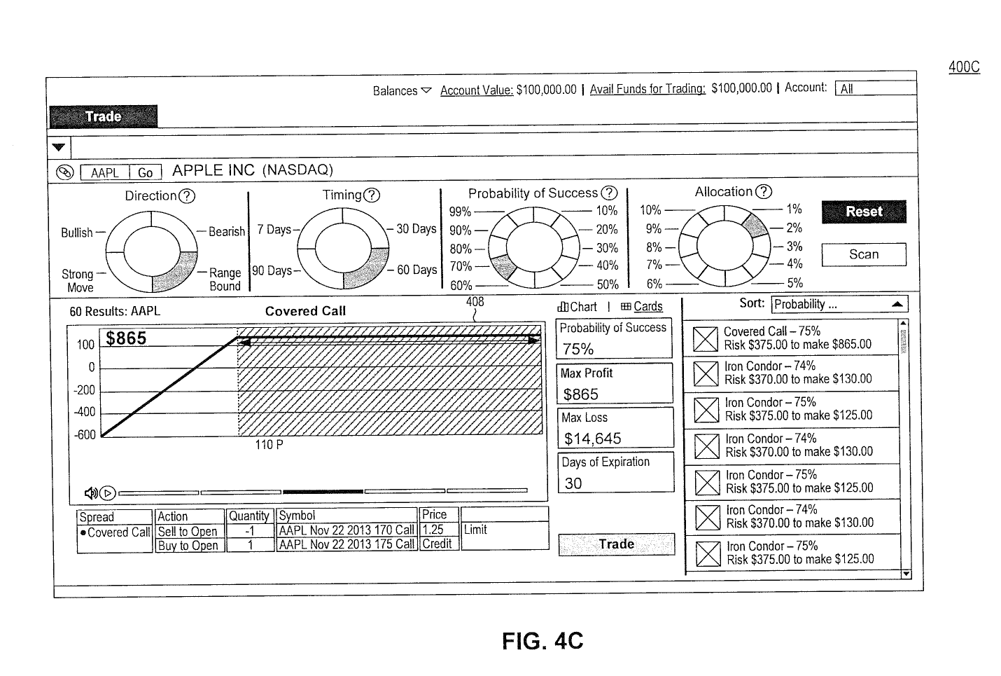

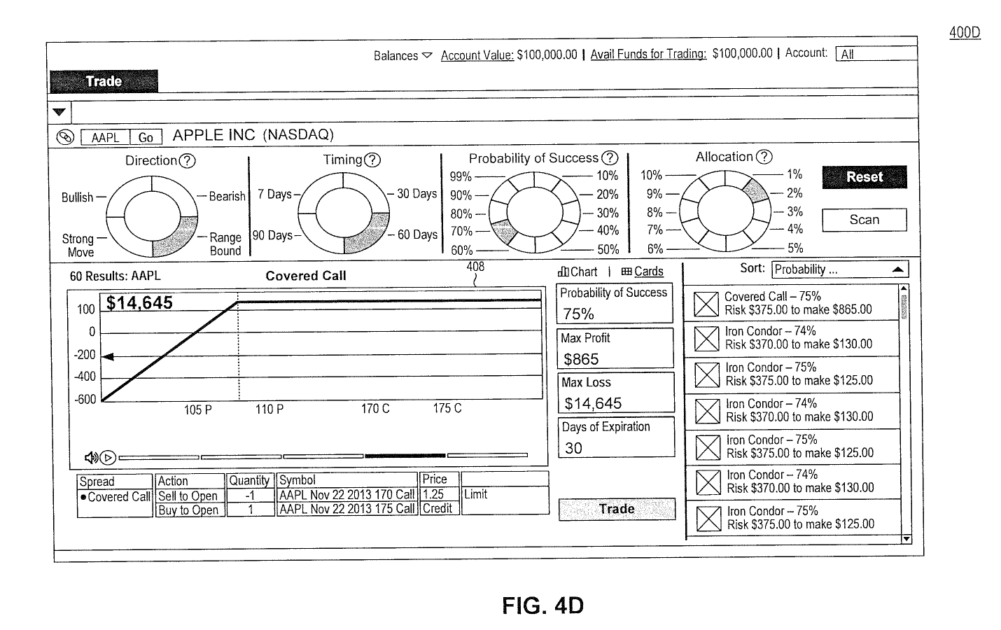

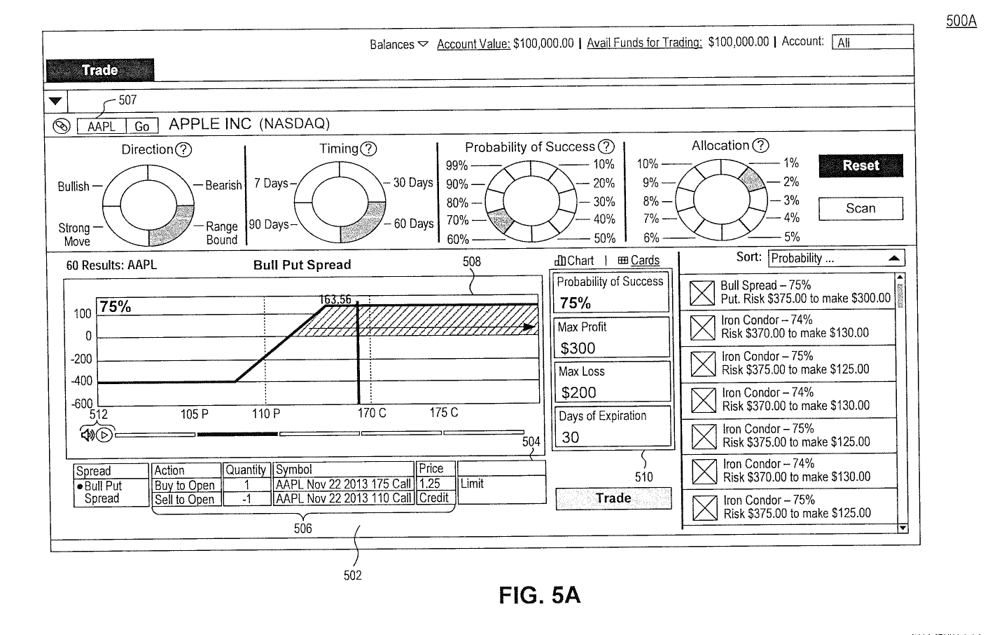

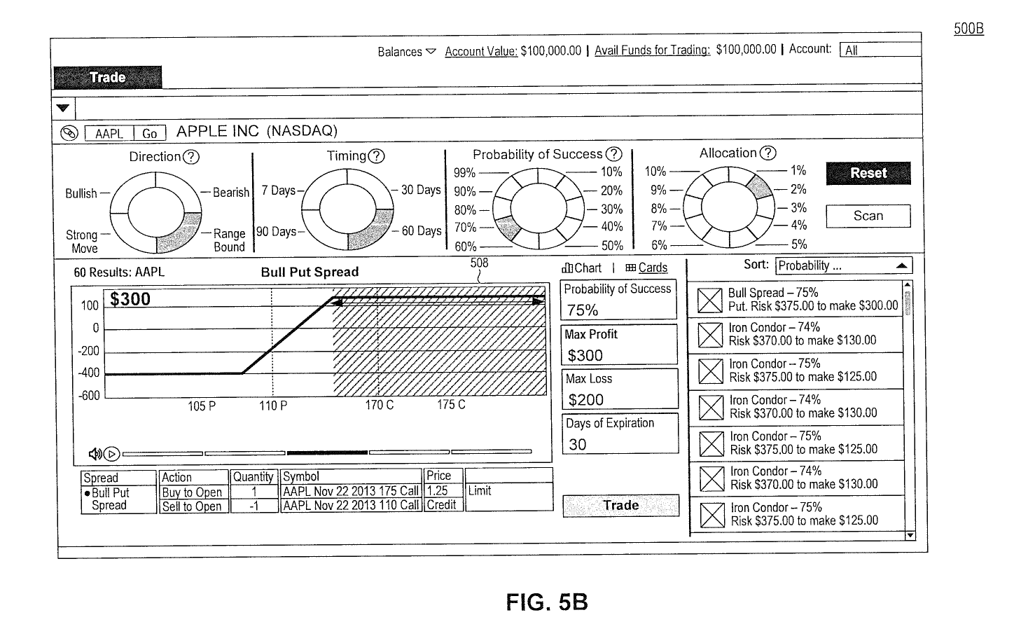

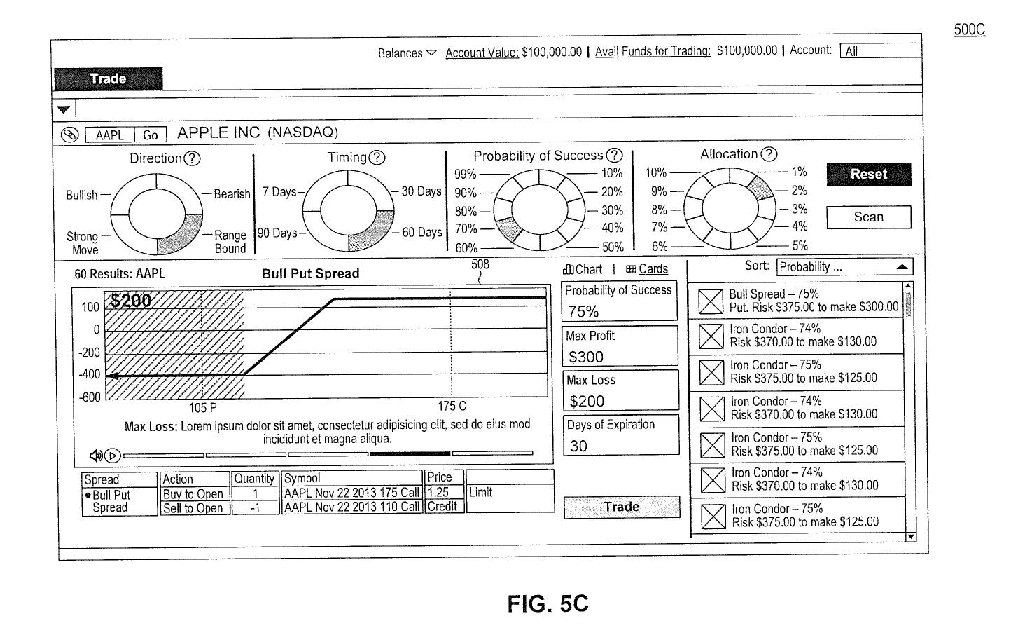

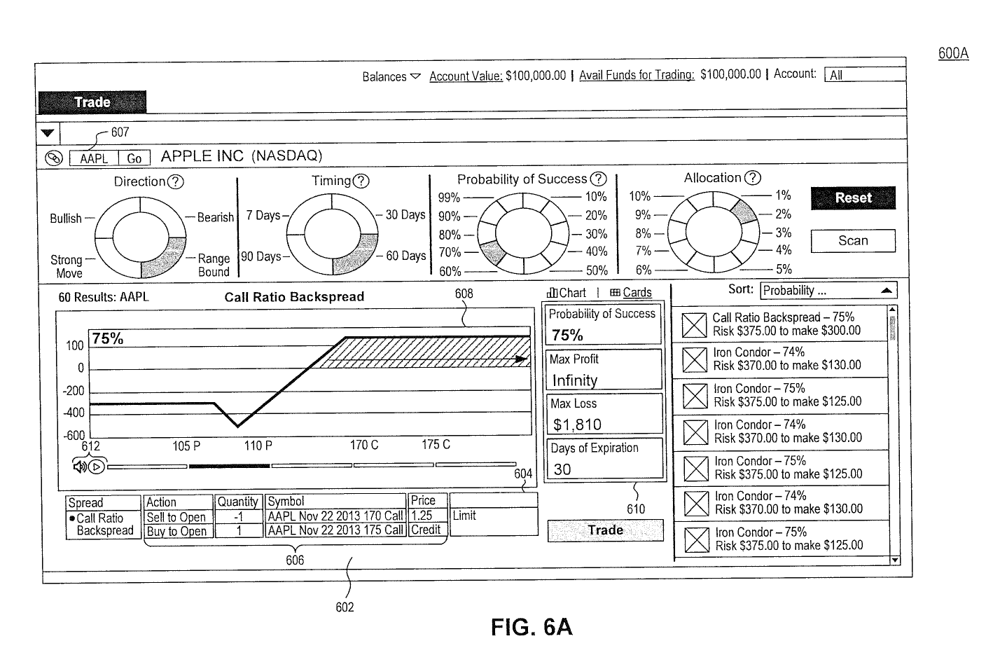

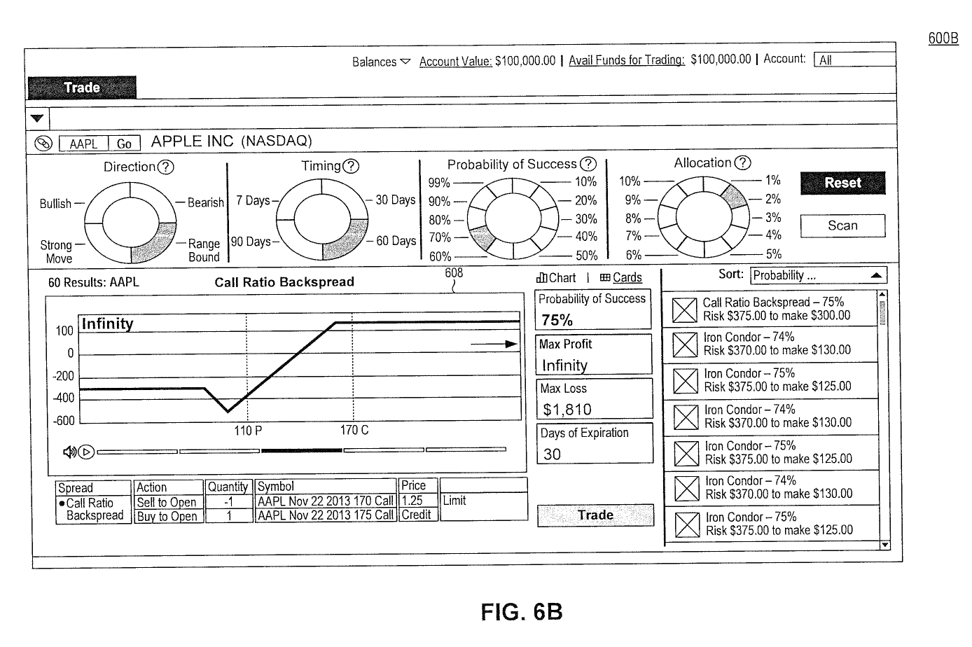

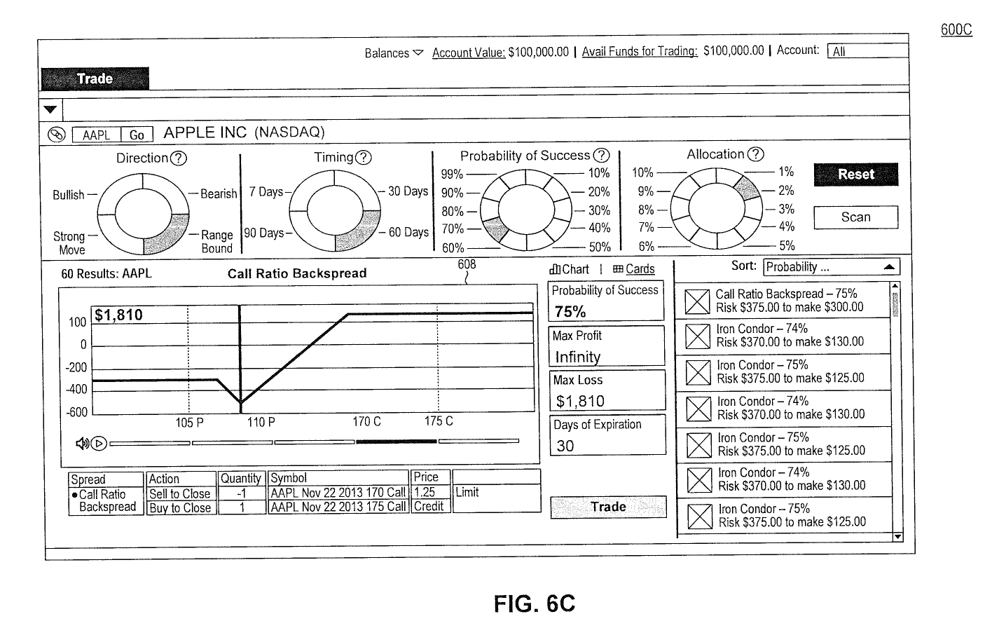

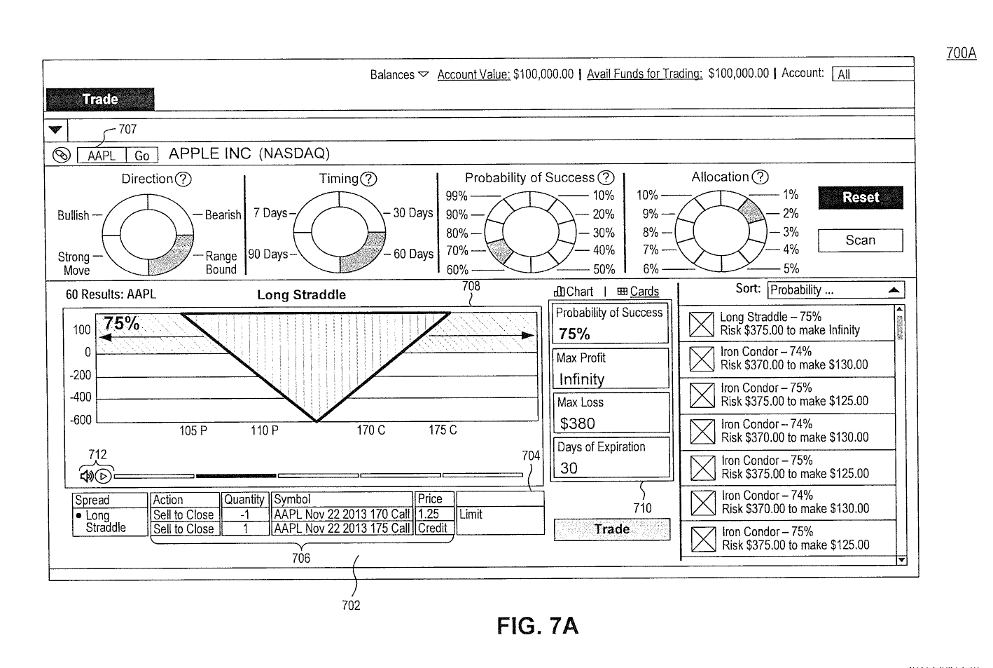

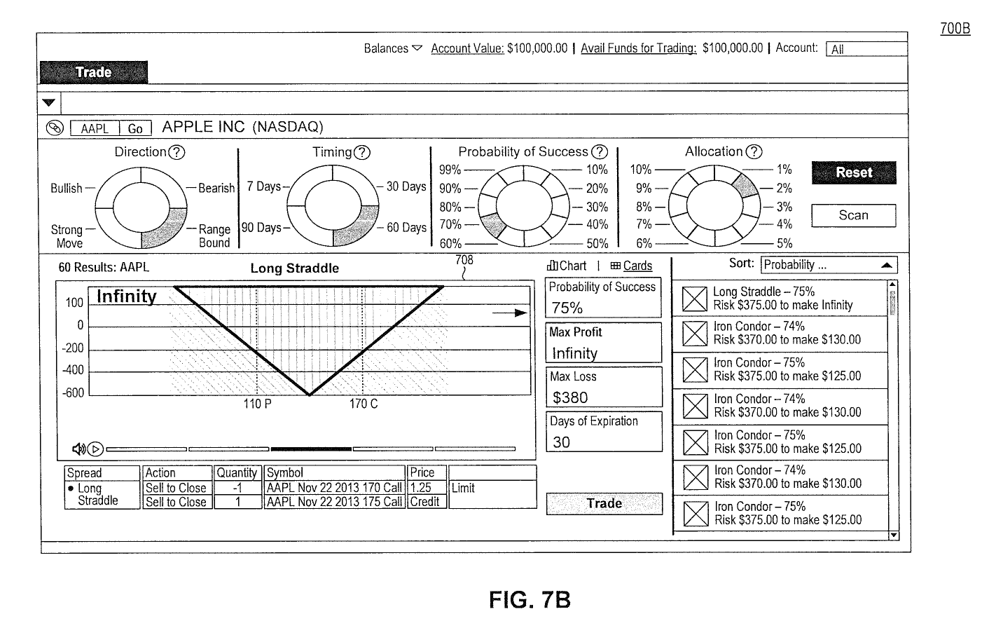

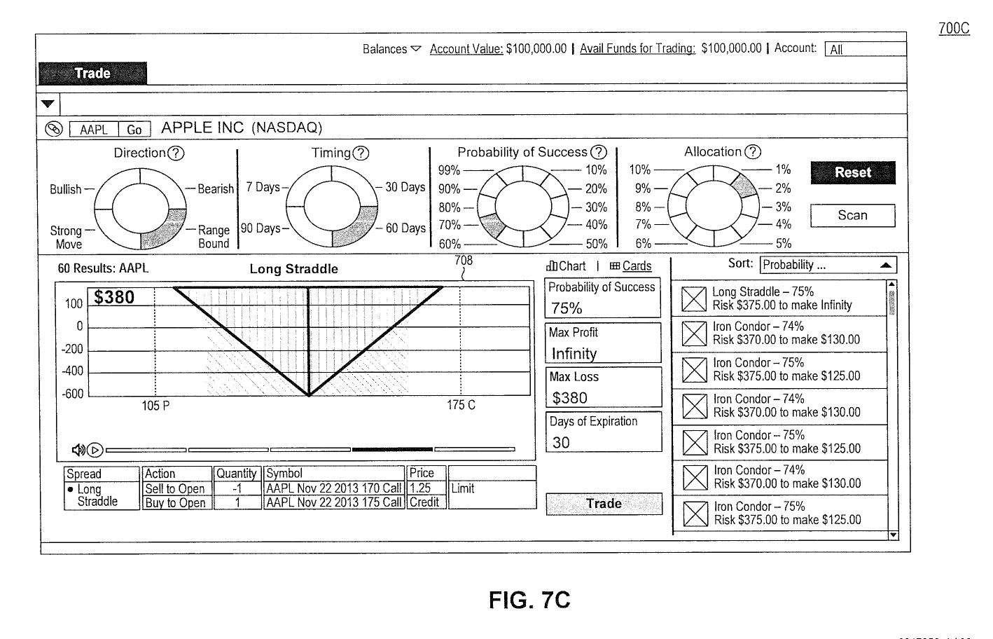

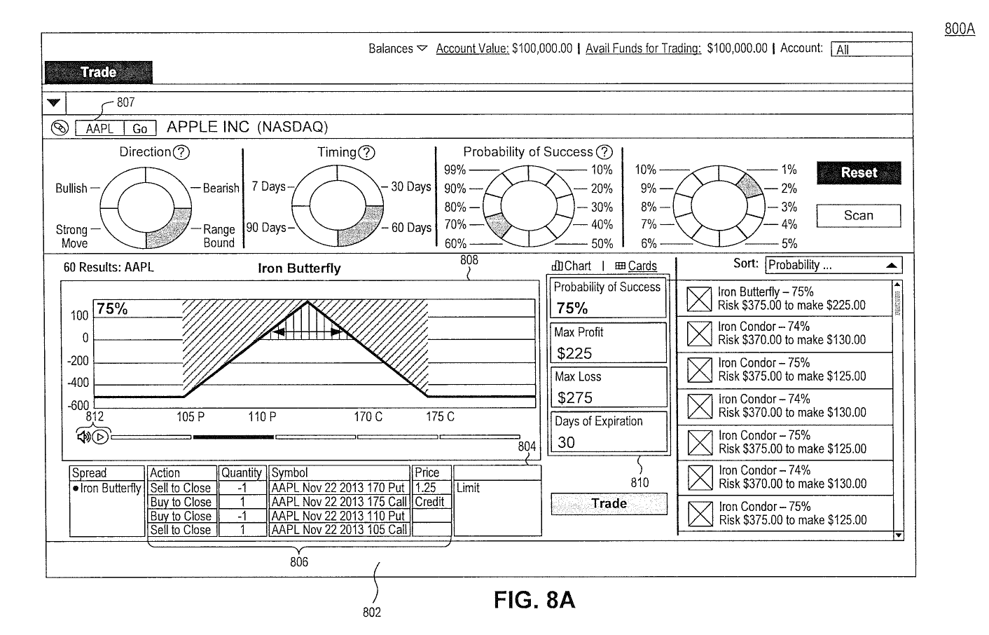

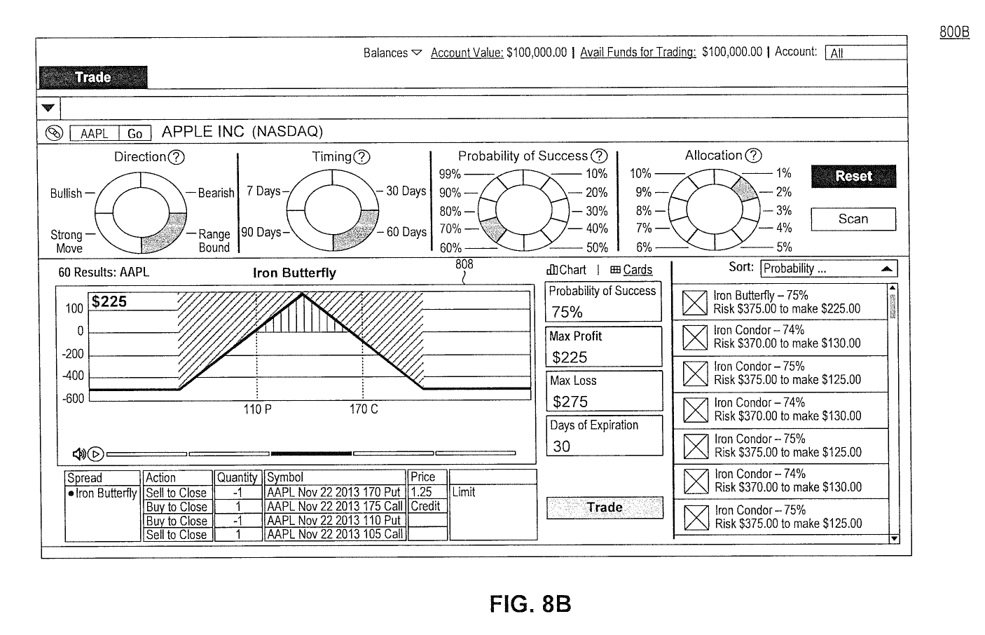

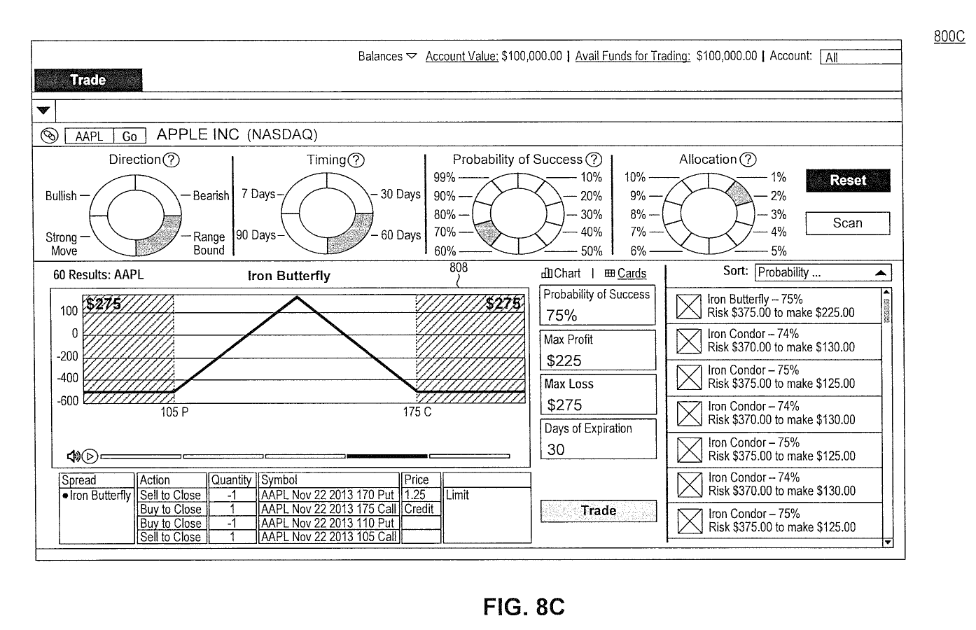

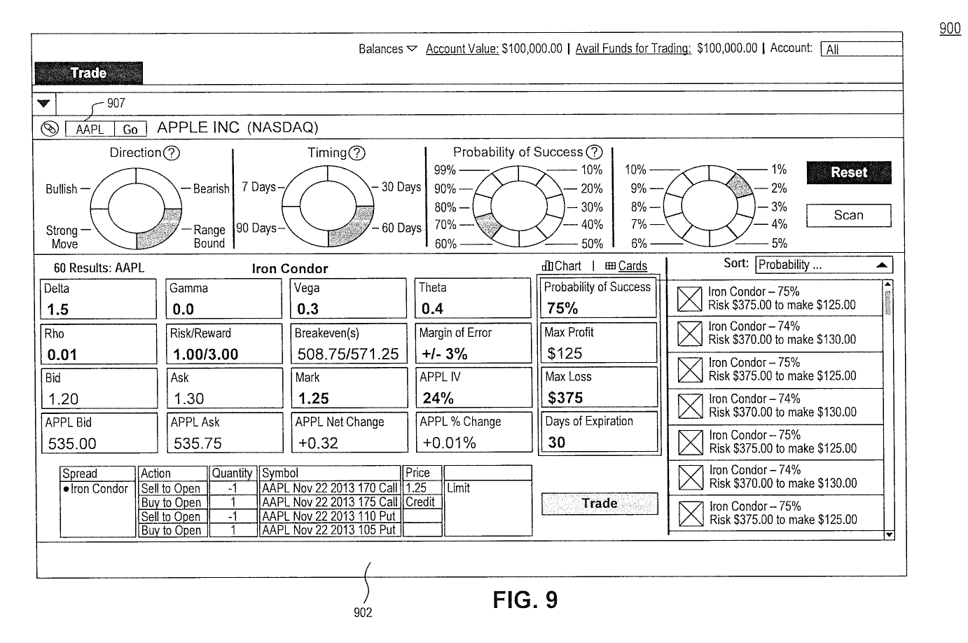

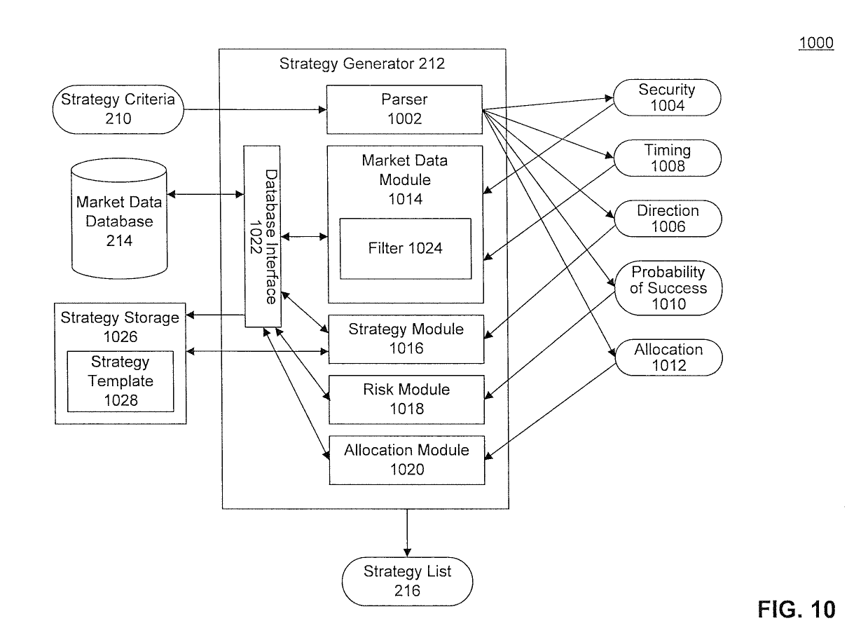

In an embodiment, FIGS. 3A-E, 4A-D, 5A-C, 6A-C, 7A-C, 8A-C and 9 are diagrams 300A-E, 400A-D, 500A-C, 600A-C, 700A-C, 800A-C and 900 of different embodiments of user interface. In a further embodiment, FIG. 10 is a block diagram 1000 of a strategy generator, according to an embodiment. The user interface and the strategy generator are addressed below.

FIG. 3A is a diagram 300A of an example user interface 202, according to an embodiment. User interface 202 may be included as part of a browser in a webpage, in a browser operating as a web-application, in a browser operating as a plugin, and/or as a native application running, for example, on an operating system of client 104. User interface 202 may be implemented as an extension of service oriented architecture (SOA), thereby enabling a single implementation of user interface 202, and/or variations thereof, to display properly on various platforms, applications, and devices potentially represented by clients 104. One having skill in the relevant art(s) would understand that the layout of user interface 202 shown for purposes of illustration in FIG. 3A may be adapted through methods such as transcoding, e.g., to other formats, display protocols, mark-up languages, suitable for displaying user interface 202 on various device types with various limitations and/or capabilities. For example, not all of the user interface components need to be displayed in a single screen and may be divided and/or sub-divided into multiple screen sections, shown in a sequence, and/or shown each on its own.

In an embodiment, user interface 202 includes one or more displays that may be populated with data from one or more sources available in system 100. For example, account display 304 displays data for one or more accounts configured to trade using system 100. The one or more accounts may hold funds on behalf of one or more individuals or financial institutions 106, be owned by financial institutions 106, etc. In an embodiment, account display 304 includes the name of the account, the monetary value of the account and the portion of the monetary value that is available for trading using system 100.

In another embodiment, market data display 306 displays market and trade data generated by trading venues 110. Example market data displayed in market data display 306 includes a list of securities listed on the one or more trading venues 110, a bid and ask price for each security in the list of securities, and the last traded price for each security. In a further embodiment, the list of securities in market data display 306 may be modified by adding or removing one or more securities from the list. In a further embodiment, a user input to market data display 306 selects a security for which strategy generator 216 generates strategy list 216. Example security selected in FIG. 3A is security 307 for “APPL.”

In another embodiment, user interface 202 includes a criteria selector 308. Criteria selector 308 receives user input selecting strategy criteria 210 from the available criteria options. As discussed above, strategy criteria 210 is data based on which strategy server 112 generates strategy list 216. In an embodiment, example criteria selectable using criteria selector 308 includes direction 310, timing 312, probability of success 314 and allocation 316 criteria. Each of the direction 310, timing 312, probability of success 314 and allocation 316 criteria may include parameters that may be selected using user interface 202 for inclusion into strategy criteria 210. A person skilled in the art will understand that the above criteria are non-limiting, and that other types of criteria may be used.

In an embodiment, direction 310 is a predicted direction a price of a stock for security 307 is expected to move during a particular time interval. Direction 310 may include one or more parameters, such as, “bullish,” “bearish,” “range bound,” and “strong move,” to name a few examples. The stock is “bullish” when the price of a stock is expected to increase during the time interval. The stock is “bearish” when the price of a stock is expected to decrease during the time interval. The stock is “range bound” when the price of the stock is expected to remain relatively the same (such as within a certain percentage of the current price) at the end of the time interval. The stock is expected to make a “strong move” when the price of the stock is expected to be significantly higher or lower (such as greater than a certain percentage of the current price) at the end of the time interval. In a further embodiment, user interface 202 may display a description of the one or more parameters for direction 310 to the user, which may aid the user in selecting a parameter. A person skilled in the art will appreciate that these parameters are not limiting, and that other parameters may also indicate direction 310 of a stock.

In an embodiment, timing 312 indicates the time interval during which the stock is expected to move in direction 310. Timing 312 may also be set to one or more parameters that include, for example, one week, one month (30 days), two months (60 days) and three months (90 days). In a further embodiment, timing 312 may also include a range of time. For example, the one week parameter may include trades that are set to expire between zero and 15 days from today, the one month parameter may include trades that are set to expire between 15 and 45 days from today, the two month parameter may include trades that are set to expire between 45 and 75 days from today, and the three month parameter may include trades that are set to expire between 75 and 105 days from today. In a further embodiment, user interface 202 may display a description of the one or more parameters for timing 312 to the user, which may aid the user in selecting a parameter. A person skilled in the art will appreciate that the above parameters are not limiting, and that other parameters may also indicate timing 312.

In an embodiment, probability of success 314 is probability of profiting from making a trade with a strategy when or before the date and/or time set in timing 312 expires. For example, probability of success 314 may be probability of making one penny or more at an expiration of a trade, not including transaction costs. In a further embodiment, a high probability of success 314 results in trades with lower profit potential and more money is at risk, whereas a low probability of success results in trades with higher profit potential and less money at risk.

In an embodiment, probability of success 314 may be selected from multiple probabilities, such as, probability at 10%, 20%, 30%, 40%, . . . , and, 99%. A person skilled in the art will understand that other probability ranges may also be included in probability of success 314. In another example, probability of success 314 may indicate a range. For example, probability of 10% may be a range indicating probability of success 314 from 0.01% to 10%, which indicates there is at most a 10% chance of making one penny or more on a trade. In another example, probability of 20% may be a range indicating probability of success 314 between 10% and 20%, which indicates there is a 10% to 20% chance of making one penny or more on a trade. In a further embodiment, user interface 202 may display a description of the one or more parameters for probability of success 314 to the user, which may aid the user in selecting a parameter.

In an embodiment, allocation 316 criteria designates a percentage of funds in the account displayed using account display 304 that may be allocated to be traded using a strategy. For example, strategy generator 212 will generate one or more strategies that have a maximum loss up to the percentage of funds in the account set in allocation 316. For example, when a monetary value of the account is $100,000 (as shown in account display 304) and allocation 316 parameter is set to 1%, the maximum loss that may occur from trading a strategy is $1000. In another embodiment, when allocation 316 is set to 2%, the maximum loss that may occur from trading a strategy is $2000. In yet another embodiment, the percentage set in allocation 316 may be rounded up to a nearest percentage. For example when allocation 316 is set to 3%, the maximum loss that may occur from a strategy is between 2.5% and 3.49% of the monetary value of the account. In a further embodiment, user interface 202 may display a description of the one or more parameters for allocation 316 to the user, which may aid the user in selecting a parameter.

In an embodiment, criteria selector 308 includes a scan button 318. When scan button 318 is selected, client 104 retrieves the parameters selected using direction 310, timing 312, probability of success 314, and allocation 316 from criteria selector 308, stores the selected categories in strategy criteria 210 and/or submits strategy criteria 210 to strategy generator 212 using architecture 100.

In an embodiment, prior to submitting strategy criteria 210, client 104 may map the selected criteria to one or more integers, strings, float, etc., values and generate a message that includes the mapped values. Client 104 then transmits the message to security generator 212. In a further embodiment, client 104 also adds security 307 to strategy criteria 210 or transmits the name of security 307 to strategy generator 212 in a separate message.

In a further embodiment, criteria selector 308 also includes a reset button 220. When reset button 320 is selected, the parameters selected in direction 310, timing 312, probability 314 and allocation 316 may reset to the default values. In response to receiving strategy criteria 210, strategy generator 212 generates strategy list 216 that includes one or more strategies, as discussed in detail in FIG. 10. Example one or more strategies are described in detail in FIGS. 3B-E, 4A-D, 5A-C, 6A-C, 7A-C, 8A-C and 9.

FIG. 3B is a diagram 300B of a user interface displaying one or more strategies, according to an embodiment. Diagram 300B includes a strategy list display 322 and a strategy display 324. Strategy display 324 displays a strategy from strategy list 216 generated using strategy generator 212. Strategy list display 322 displays a synopsis of one or more strategies in strategy list 216. Depending on an embodiment, the synopsis may be a description or a graphical representation of each strategy and its attributes. Strategy list display 322 may also be divided into visible and invisible portions. In FIG. 3B, the visible portion includes seven strategies called “iron candor,” each strategy associated with a same or different combination of strategy attributes that fit strategy criteria 210. Example strategy attributes includes strategy type, probability of success, loss and profit potential, and days to expiration attributes. The invisible portion of strategy list display 322 includes other strategies generated using strategy generator 212. Strategies included in the invisible portion may be displayed using a scrolling mechanism 333 associated with strategy list display 322.

In a further embodiment, one of the strategies displayed using strategy list display 322 may be selected for display using strategy display 324. Strategy display 324 displays the selected strategy, referred to as strategy 326, and attributes of strategy 326. Example, strategy 326 displayed in FIG. 3B is called an “Iron Condor.”

In an embodiment, strategy display 324 includes an attribute display 328, a graphical representation display 330, and a trade display 332. Attribute display 328 displays attributes associated with strategy 326, while graphical representation display 330 displays the graphical representation of strategy 326 and one or more of the attributes associated with strategy 326. These attributes may be determined using strategy generator 212. Example attributes include probability of success 334, maximum profit (or max profit) 336, maximum loss (or max loss) 338 and days to expiration 340. In a further embodiment, attributes displayed within attribute display 328 may be selected and displayed using graphical representation display 330.

In an embodiment, probability of success 334 identifies probability of strategy 326 making money before or when strategy 326 expires. For example, in FIG. 3B, the “iron condor” strategy has a probability of success of 75%. In a further embodiment, when probability of success 334 attribute is selected, graphical representation display 330 displays the graphical representation of probability of success 334 as shown in FIG. 3C.

Going back to FIG. 3B, maximum profit 336 identifies the maximum amount of money that can be made by trading or exercising strategy 326. In a further embodiment, when maximum profit 336 attribute is selected, graphical representation display 330 displays the graphical representation of maximum profit 336 as shown in FIG. 3D. Graphical representation display 330 shows the price points at which strategy 326 may generate maximum profit 336. Example maximum profit for strategy 326 in FIG. 3D is $125.

Going back to FIG. 3B, maximum loss 338 identifies the maximum amount of money that can be lost when strategy 326 expires in a market where it cannot be exercised. In a further embodiment, when maximum loss 338 attribute is selected, graphical representation display 330 displays the graphical representation of maximum loss 338 as shown in FIG. 3E. Graphical representation display 330 shows the price points at which strategy 326 may result in maximum loss 338. Example maximum profit for strategy 326 in FIG. 3E is $375.

Going back to FIG. 3B, day to expiration 340 identifies the time, such as a number of days, weeks, or months until strategy 326 expires.

In an embodiment, trade display 332 displays financial instruments 342 included in strategy 326, and attribute display 328 displays attributes associated with strategy 326. For example, the “iron condor” strategy include four financial instruments 342, that for example, may be two call options and two put option for the same quantity and having the same expiration date (Nov. 22, 2013), as shown in FIG. 3B.

In an embodiment, strategy display 324 also includes a trade button 344. When trade button 344 is selected, client 104 issues a request to trade strategy 326 using trading platform 108 and on one or more trading venues 110.

In an embodiment, strategy display also includes a strategy educator button 346. Strategy educator button 346 initiates educator 208. Educator 208 retrieves and shows a pre-recorded educational video and/or audio that may be viewed using graphical representation display 330. The pre-recorded educational video may describe strategy 326, the attributes associated with strategy 326 in attribute display 328 and financial instruments 342 that are included in strategy 326. In a further embodiment, the educational video may also describe how probability of success 334, maximum profit 336, maximum loss 338 and days to expiration 340 are calculated.

In an embodiment, educational videos displayed using graphical representation interface 330 that educate a user on different types of strategies and market conditions for when the strategies become profitable, and also provide information that facilitates the user decision to trade using strategy 326 to minimize loss and maximize profit to the portfolio. Example strategy types, as may be taught using educator 208 are briefly discussed below.

For example, a long call is a strategy which becomes profitable when a stock trades above the break even point. A long call strategy comprises a single call option.

In another example, a long put is a strategy which becomes profitable when the stock trades below the break even point. A long put strategy comprises a single put option that allows an investor to purchase stock at market prices and sell at the strike price.

In another example, a short call strategy is profitable when the stock trades below the break even point. The short call strategy includes a single call option and allows a holder to sell a security, such as a stock, at a lower price at a certain time period in the future.

In another example, a short put strategy is profitable when the stock trades above the break even point. The short put strategy includes a single put option and allows a holder to sell the put option at a predetermined price, at a certain point in the future.

In another example, a long straddle is a strategy which requires the stock to make a strong move to either a higher or lower price from its current price. A long straddle comprises buying two options—a call option and a put option, where the call option and the put option have the same strike price and the same expiration date.

In another example, a short straddle is a range bound strategy which becomes profitable when a stock trades within a defined price range at the end of the trade. A short straddle comprises selling two options—a call option and a put option, where the call option and a put option have the same strike price and the expiration date.

In another example, a bear call spread is a strategy that is profitable when a stock trades below the break even point at expiration. The bear call spread strategy comprises selling one call option at a particular strike price, and then buying another call option at a higher strike price.

In another example, a bear put spread is a strategy that is profitable when a stock trades below the break even point at expiration. The bear put spread strategy comprises buying one put option and selling another put option at a lower strike price.

In another example, a short put butterfly strategy is profitable when a stock makes a strong move to either a higher or lower price. A short put butterfly strategy comprises buying two put options at a middle strike price and selling one put option at a lower strike price and the second put option at an upper strike price, where the lower strike price and the upper strike price are the same distance from the middle strike price.

In another example, an iron butterfly strategy is profitable when a stock trades within a defined price range at the end of the trade. The iron butterfly strategy comprises four options, where the four options have the same expiration date. A short call and a short put are both sold at the middle strike price, and a call option and a put option are purchased above and below the middle strike price.

In another example, a long strangle strategy is a strategy which requires a stock to make a strong move to either a higher or lower price. A long strangle is a two option strategy that includes buying an out-of-the money call option and an out-of-the money put option with the same expiration date.

In another example, a short strangle strategy is a range bound strategy which will profit if the stock trades within a defined range at the end of the trade. A short strangle is a two option strategy that includes selling a call option and a put option with the same expiration date and the same strike price.

In another example, a bear put spread is a strategy that is profitable when a stock trades below the break even point at expiration. A bear put spread is a two option strategy that includes buying one put option and selling another put option, at a lower strike.

In another example, a long call ratio back-spread strategy is a strong bullish strategy that provides protection when a stock moves strongly to the downside. A long call ratio back-spread is a multi-option strategy that includes selling call options at a lower strike price and simultaneously buying a greater number of call options with a higher strike price.

In another example, a reverse iron butterfly strategy requires the stock to make a strong move to either higher or lower price. A reverse iron butterfly strategy includes four options, two call options and two put options, and involves selling at a lower price an out-of-money put option, buying a middle strike at-the-money put option, buying a middle strike at-the-money call option and selling another higher strike out-of-the-money call option.

In another example, a long call condor is a strategy that is profitable when the stock trades within a defined range at the end of the trade. A long call condor strategy includes two call options and two put options having the same expiration date.

In another example, a covered call strategy is profitable if the stock trades at the current value or higher. A covered call strategy includes an ownership in a security and a call option with a strike price higher than the price of the security.

In another example, a protective put strategy is a strategy with a bullish long term outlook that also protects short term uncertainty or bearishness. A protective put strategy includes an ownership in a security and also buying a put option that safeguards against a loss of the value of the security.

In another example, a long call butterfly strategy is a range bound strategy which will profit if the stock trades within a defined range at the end of the trade. A long call butterfly includes two short call options having a middle strike price, a long call option having an upper strike price, and a long call option having a lower strike price, where the upper strike price and the lower strike price are equidistant from the middle strike price.

In another example, a short call butterfly strategy is a strategy which requires the stock to make a strong move either higher or lower. The short call butterfly strategy includes two long call options at a middle strike price, a short call option at a lower strike price, and a short call option at a higher strike price, where the lower strike price and the higher strike price are equidistant from the middle strike price.

In another example, a long put ratio back-spread strategy is a strong bearish strategy with some protection if the stock moves strongly to the upside. A long put ratio back-spread strategy included multiple long and short put options according to a ratio, where there are more long put options than short put options. Example ratios of long:short put options include 2:1, 3:2, or 3:1.

In another example, a reverse iron condor strategy requires the stock to make a strong move to either a higher or lower price. A reverse iron condor strategy includes four options, two call options and two put options, and involves buying a lower strike out-of-the-money put option, selling an even lower strike out-of-the-money put option, buying a higher strike out-of-the-money call option, and selling another even higher strike out-of-the-money call option.

In another example, a short call condor strategy requires the stock to make a strong move either higher or lower. A short call condor strategy includes four call options, and involves buying a lower strike in-the-money call option, selling an even lower strike in-the-money call option, buying a higher strike out-of-the-money call option, and selling another even higher strike out-of-the-money call option.

In another example, an iron condor strategy is profitable as long as the stock's price stays within a defined range at the end of the trade. An iron condor strategy includes four options, two put options and two call options having the same expiration date, and involves selling a lower strike out-of-the-money put option, buying an even lower strike out-of-the-money put option, selling a higher strike out-of-the-money call option and buying another even higher strike out-of-the-money call option.

In another example, a collar strategy is used to protect a profit on stock when there is a slightly lower outlook on the future value of the underlying stock. A collar strategy includes shares of a stock, a call option and a put option, and involves simultaneously buying a put option and selling a call option, where the call option and the put option are both out-of-the-money options having the same expiration month and are for an equal number of contracts.

In another example, a short put condor strategy requires the stock to make a strong move either higher or lower. A short put condor includes four put options, and involves selling a lower strike put option, buying a middle strike put option, buying a higher middle strike put option, and selling an even higher strike put option, where all put options expire the same month, and a distance between to two lower priced options is equal to the distance between the two higher priced options.

In another example, a long put butterfly strategy is profitable as long as the stock's price is within a defined range at the end of the trade. The long put butterfly strategy includes two short put options at a middle strike price, a long put option at a lower strike price and a long put option at a higher strike price, where the lower strike price and the higher strike price are equidistant from the middle strike price.

In another example, a long put condor strategy is profitable when the stock trades within a defined range at the end of the trade. A long put condor strategy includes four put options having the same expiration date. The first option is a long out-of-money put option having a lowest strike price. The second option is a short out-of-money put option having a middle strike price. The third option is a higher in-the-money put option having a higher strike price. And the fourth option is a long deeper in-the-money put option having a highest strike price.

In another example, a bull call spread strategy is profitable when the stock trades above the breakeven value at expiration of the strategy. The bull call spread strategy includes buying a short call option and selling a long call option at a higher strike price, where the short call option and the long call option have the same expiration date.

FIGS. 4A-4D are diagrams 400A-D of a user interface displaying a strategy, according to an embodiment. In FIG. 4A a strategy display 402 displays a “covered call” strategy, having attributes including probability of success of 75%, maximum profit of $865, maximum loss of $14,645, and an expiration date of 30 days. Strategy display 402 also includes a trade display 404 that displays the two financial instruments 406 that comprise a “covered call” strategy.

In an embodiment, graphical representation display 408 displays attributes associated with the “covered call” strategy. As shown in FIGS. 4B-4D strategy display 408 may display the attributes when either an attribute is selected from attribute display 410 or strategy educator button 412 activates educator 208 and educator 208 display a video discussing the attributes of the strategy. In FIG. 4B graph representation display 408 shows a graph representation of the “covered call” strategy with a probability of success of 75%, according to an embodiment. In FIG. 4C, graph representation display 408 shows a graph of the “covered call” strategy and the prices that would generate a maximum profit of $865. In FIG. 4D, graph representation display 408 shows a graph of the “covered call” strategy and the prices that would generate a maximum loss of $14,645.

FIGS. 5A-5C are diagrams 500A-C of a user interface displaying a strategy, according to an embodiment. In FIG. 5A a strategy display 502 displays a “bull put spread” strategy, having attributes including probability of success of 75%, maximum profit of $300, maximum loss of $200, and an expiration date of 30 days. Strategy display 502 also includes a trade display 504 that displays financial instruments 506 that comprise a “bull put spread” strategy.

In an embodiment, graphical representation display 508 displays attributes associated with the “bull put spread” strategy. In FIG. 5A graph representation display 508 shows a graph representation of the “bull put spread” strategy with a probability of success of 75%, according to an embodiment. In FIG. 5B, graph representation display 508 shows a graph of the “bull put spread” strategy and the prices that would generate a maximum profit of $300. In FIG. 5C, graph representation display 508 shows a graph of the “bull put spread” strategy and the price that would generate a maximum loss of $200.

FIGS. 6A-6C are diagrams 600A-C of a user interface displaying a strategy, according to an embodiment. In FIG. 6A a strategy display 602 displays a “call ratio back-spread” strategy, having attributes including probability of success of 75%, an infinite maximum profit, maximum loss of $1,830, and an expiration date of 30 days. Strategy display 602 also includes a trade display 604 that displays financial instruments 606 that comprise a “call ratio back-spread” strategy.

In an embodiment, graphical representation display 608 displays attributes associated with the “call ratio back-spread” strategy. In FIG. 6A graph representation display 608 shows a graph representation of the “call ratio back-spread” strategy with a probability of success of 75%, according to an embodiment. In FIG. 6B, graph representation display 608 shows a graph of the “call ratio back-spread” strategy and the prices that would generate an infinite profit. In FIG. 6C, graph representation display 608 shows a graph of the “call ratio back-spread” strategy and the prices that would generate a maximum loss of $1,810.

FIGS. 7A-7C are diagrams 700A-C of a user interface displaying a strategy, according to an embodiment. In FIG. 7A a strategy display 702 displays a “long straddle” strategy, having attributes including probability of success of 75%, an infinite maximum profit, maximum loss of $380, and an expiration date of 30 days. Strategy display 702 also includes a trade display 704 that displays financial instruments 706 that comprise a “long straddle” strategy.

In an embodiment, graphical representation display 708 displays attributes associated with the “long straddle” strategy. In FIG. 7A graph representation display 708 shows a graph representation of the “long straddle” strategy with a probability of success of 75%, according to an embodiment. In FIG. 7B, graph representation display 708 shows a graph of the “long straddle” strategy and the prices that would generate an infinite profit. In FIG. 7C, graph representation display 708 shows a graph of the “long straddle” strategy and the prices that would generate a maximum loss of $380.

FIGS. 8A-8C are diagrams 800A-C of a user interface displaying a strategy, according to an embodiment. In FIG. 8A, a strategy display 802 displays an “iron butterfly” strategy, having attributes including probability of success of 75%, maximum profit of $225, maximum loss of $275, and an expiration date of 30 days. Strategy display 802 also includes a trade display 804 that displays financial instruments 806 that comprise an “iron butterfly” strategy.

In an embodiment, graphical representation display 808 displays attributes associated with the “iron butterfly” strategy. In FIG. 8A graph representation display 808 shows a graph representation of the “iron butterfly” strategy with a probability of success of 75%, according to an embodiment. In FIG. 8B, graph representation display 808 shows a graph of the “iron butterfly” strategy and the prices that would generate a maximum profit of $225. In FIG. 8C, graph representation display 808 shows a graph of the “iron butterfly” strategy and the prices that would generate a maximum loss of $275.

FIG. 9 is a block diagram 900 of a user interface displaying strategy and market data information, according to an embodiment. The strategy and market data information provide additional data showing present and future market conditions that may be required to profit from a selected strategy. For example, strategy display 902 displays market data information which may include the bid and ask price of the selected security 907, and may be retrieved from trading platform 108. In another example, user interface 202 displays the break even points or break evens. The break even points are the price points that the stock of security 907 must reach for an investor to profit from trading the strategy, and may be determined using strategy generator 212, as discussed below. In another example, strategy display 902 also includes the “delta,” “gamma,” “vega,” “theta” and “rho” variables, which are known in the art and may be determined using trading platform 108.

FIG. 10 is a block diagram 1000 of a strategy generator, according to an embodiment. Strategy generator 212 generates one or more strategies using strategy criteria 210 and the market data stored in market data database 214. Strategy generator 212 includes a parser 1002. Parser 1002 parses strategy criteria 210, and identifies the parameters included in strategy criteria 210. For example, parser 1002 parses the parameters for security 307, direction 310, timing 312, probability of success 314, and allocation 316. The parsed parameters are security 1004, direction 1006, timing 1008, probability of success 1010 and allocation 1012.

In an embodiment, probability of success 314 may be one or more values and include a minimum probability and a maximum probability. When probability of success 314 includes more than one value, parser 1002 parses the minimum probability and the maximum probability from probability of success 314 and stores both values in probability of success 1010.

In an embodiment, allocation 316 may be a range of values, ranging from a minimum percent allocation and a maximum percent allocation. When allocation 316 is a range of values, parser 1002 parses the minimum percent allocation and the maximum percent allocation from allocation 316 and stores both values in allocation 1012. When allocation 1012 includes a minimum percent allocation and a maximum percent allocation, strategy generator 212 determines the minimum and maximum portfolio allocations that may be allocated for a strategy. In an embodiment, strategy generator 212 determines the minimum and maximum portfolio allocation as follows:

minimum portfolio allocation=the minimum percent allocation*the account value

and

maximum portfolio allocation=the maximum percent allocation*the account value.

To generate strategy list 216, strategy generator 212 includes several specialized modules configured for fast and efficient processing large quantities of real-time data, including a market data module 1014, strategy module 1016, risk module 1018, and allocation module 1020.

In an embodiment, one or more strategies in strategy list 216 are generated from one or more financial instruments stored in market data database 214. In an alternative embodiment, another storage mechanism compatible with storing large quantities of real-time data may be used. As discussed above, market data database 214 stores data, including financial instruments that are traded using one or more trading venues 110 and that are disseminated to trading platform 108 throughout the day. Market data module 1014 accesses market data database 214 to retrieve financial instruments, such as options, binary options, stocks, etc. Included in the financial instruments, are also one or more attributes that are associated with or describe the financial instruments, including, a bid and/or ask price, strike price, last price, bid and/or ask size, expiration date, financial instrument type, yield, etc. In an embodiment, strategy generator 212 includes a database interface 1022. Database interface 1022 generates one or more queries for retrieved data from market data database 214. The one or more queries include, for example, security 1004 and transmit the generated query to market data database 214. Market data database 214 uses the query to retrieve the one or more financial instruments that are selected using the query and returns the one or more financial instruments to market data module 1014. For example, when the one or more queries include security 1004, the query returns the one or more financial instruments associated with security 1004.

In an embodiment, market data module 1014 also includes a filter 1024. Filter 1024 includes configurable criteria that may filter the one or more financial instruments retrieved from market data database 214 according to the configurable criteria. In a further embodiment, filter 1024 may filter the one or more financial instruments based on timing 1008. For example, filter 1024 excludes the one or more financial instruments that have an expiration date outside of the date stored in timing 1008, and, as a result, reduces the available financial instruments that strategy generator 212 uses to generate strategies for strategy list 216.

In an embodiment, strategy module 1016 generates one or more strategies using one or more financial instruments selected using market data module 1014 and strategy criteria 210. To generate the one or more strategies, strategy module 1016 accesses strategy storage 1026. Strategy storage 1026 stores one or more strategy templates 1028. Strategy storage 1026 may be a main or secondary storage described in FIG. 13. The one or more strategy templates 1028 are blank strategies that do not include financial instruments. Strategy templates may templates for one or more strategies described above, and have stock price, strike price, price interval, expiration date, etc., requirements that may be filled using one or more financial instruments. Also, each strategy template 1028 may be suited for trading during different market conditions. For example strategy templates 1028 for a long call, short put, bull call spread, bull put spread, covered call, collar, protective put, call ratio back-spread, and diagonal call strategies may be suitable for bullish market conditions. In another example, strategy templates 1028 for a long put, short call, bear call spread, bear put spread, put ratio back-spread, and diagonal put spread may be suitable for bearish market conditions. In another example, a calendar call spread, calendar put spread, short straddle, short strangle, long call butterfly, long put butterfly, long call condor, long put condor, iron butterfly, and iron condor strategies may be suitable for neutral market conditions. In another example, a long straddle, long strangle, short call butterfly, short put butterfly, short call condor, short put condor, reverse iron butterfly, and reverse iron condor strategies may be suitable for market conditions that expect a strong move of a stock price.

In an embodiment, strategy module 1016 may use criteria, such as, direction 1006 to select one or more strategy templates 1028 from strategy storage 1026. For example, when direction 1006 is set to a “bullish” market, strategy module 1016 selects strategy templates 1028 that are associated with the bullish market conditions, or when direction 1006 is set to a “bearish” market, strategy module 1016 selects strategy templates 1028 that are associated with the bearish market conditions, etc.

In an embodiment, each strategy comprises of one or more financial instruments, such as one or more options, a combination of stock(s) and option(s), etc. Each option in a strategy is referred to as a “leg”. When strategy template 1028 incorporates one, two, three, or four options, strategy template 1028 has one, two, three or four legs, respectively.

In an embodiment, to generate one or more strategies for strategy list 216, strategy module 1016 generates strategy candidates. Strategy candidates are strategy templates 1028 which include financial instruments selected using market data module 1014 that fit some, but not all, strategy criteria 210. To generate strategy candidates, strategy module 1016 includes one or more financial instruments into the one or more legs, as specified for each strategy template 1028. For example, for strategy template 1028 which has a single leg, strategy module 1016 generates strategy candidates that include financial instruments which are options, one financial instrument for each strategy candidate.

In another embodiment, for each strategy template 1028 that includes two legs, strategy module 1016 generates strategy candidates that include two financial instrument combinations. Example strategy templates 1028 that include two legs are vertical strategies, calendar strategies, diagonal strategies and straddle/strangle strategies. In an embodiment, when direction 1006 indicates bullish market conditions, strategy module 1016 may determine the option leg combinations for strategy candidates as shown in Table 1, below.

TABLE 1

| Spread | Resulting Strike Price Combinations |
|---|---|
| 1 | ATM strike/ATM + 1 strike |
| 1 | ATM − 1 strike/ATM strike |
| 1 | ATM − 2 strike/ATM − 1 strike |
| 1 | ATM − 3 strike/ATM − 2 strike |
| 2 | ATM strike/ATM + 2 strike |
| 2 | ATM − 1 strike/ATM + 1 strike |
| 2 | ATM − 2 strike/ATM strike |
| 2 | ATM − 3 strike/ATM − 1 strike |
| 3 | ATM strike/ATM + 3 strike |
| 3 | ATM − 1 strike/ATM + 2 strike |
| 3 | ATM − 2 strike/ATM + 1 strike |
| 3 | ATM − 3 strike/ATM strike |
| 4 | ATM strike/ATM + 4 strike |
| 4 | ATM − 1 strike/ATM + 3 strike |
| 4 | ATM − 2 strike/ATM + 2 strike |
| 4 | ATM − 3 strike/ATM + 1 strike |

A “strike” or “strike price” is a price at which an option can be exercised when it expires. An “ATM” is a situation where a strike price is the same as the stock price of an underlying security.

In an embodiment, when direction 1006 indicates bearish market conditions, strategy module 1016 may determine the option leg combinations for strategy candidates as shown in Table 2, below.

TABLE 2

| Spread | Resulting Strike Price Combination |
|---|---|
| 1 | ATM strike/ATM − 1 strike |
| 1 | ATM + 1 strike/ATM strike |
| 1 | ATM + 2 strike/ATM + 1 strike |
| 1 | ATM + 3 strike/ATM + 2 strike |
| 2 | ATM strike/ATM − 2 strike |
| 2 | ATM + 1 strike/ATM − 1 strike |
| 2 | ATM + 2 strike/ATM strike |
| 2 | ATM + 3 strike/ATM + 1 strike |
| 3 | ATM strike/ATM − 3 strike |
| 3 | ATM + 1 strike/ATM − 2 strike |
| 3 | ATM + 2 strike/ATM − 1 strike |
| 3 | ATM + 3 strike/ATM strike |
| 4 | ATM strike/ATM − 4 strike |
| 4 | ATM + 1 strike/ATM − 3 strike |
| 4 | ATM + 2 strike/ATM − 2 strike |
| 4 | ATM + 3 strike/ATM − 1 strike |

In another embodiment, for each strategy template 1028 that includes three or four legs, strategy module 1016 generates strategy candidates that include three or four financial instrument combinations, one financial instrument for each leg. Example strategy templates 1028 that include three or four legs are various butterfly strategies and condor strategies. In an embodiment, strategy module 1016 may determine the option leg combinations for strategy candidates as shown using exemplary combinations in Table 3, below. In a further embodiment, strategy module 1016 may select a particular combinations depending on direction 1006 indicating bearish or bullish market conditions.

TABLE 3

| | Spread | |
|---|---|---|
| Spread Center | Vertical | |
| Width | Width | Resulting Strike Price Combinations |
| 0 | 1 | ATM − 1 strike/ATM + 1 strike |
| 0 | 2 | ATM − 2 strike/ATM + 2 strike |
| 0 | 3 | ATM − 3 strike/ATM + 3 strike |
| 0 | 4 | ATM − 4 strike/ATM + 4 strike |
| 1 | 1 | ATM − 2 strike/ATM − 1 strike/ATM + 1 strike/ATM + 2 strike |
| 1 | 2 | ATM − 3 strike/ATM − 1 strike/ATM + 1 strike/ATM + 3 strike |
| 1 | 3 | ATM − 4 strike/ATM − 1 strike/ATM + 1 strike/ATM + 4 strike |
| 1 | 4 | ATM − 5 strike/ATM − 1 strike/ATM + 1 strike/ATM + 5 strike |
| 2 | 1 | ATM − 3 strike/ATM − 2 strike/ATM + 2 strike/ATM + 3 strike |
| 2 | 2 | ATM − 4 strike/ATM − 2 strike/ATM + 2 strike/ATM + 4 strike |
| 2 | 3 | ATM − 5 strike/ATM − 2 strike/ATM + 2 strike/ATM + 5 strike |
| 2 | 4 | ATM − 6 strike/ATM − 2 strike/ATM + 2 strike/ATM + 6 strike |
| 3 | 1 | ATM − 4 strike/ATM − 3 strike/ATM + 3 strike/ATM + 4 strike |
| 3 | 2 | ATM − 5 strike/ATM − 3 strike/ATM + 3 strike/ATM + 5 strike |
| 3 | 3 | ATM − 6 strike/ATM − 3 strike/ATM + 3 strike/ATM + 6 strike |
| 3 | 4 | ATM − 7 strike/ATM − 3 strike/ATM + 3 strike/ATM + 7 strike |
| 4 | 1 | ATM − 5 strike/ATM − 4 strike/ATM + 4 strike/ATM + 5 strike |
| 4 | 2 | ATM − 6 strike/ATM − 4 strike/ATM + 4 strike/ATM + 6 strike |
| 4 | 3 | ATM − 7 strike/ATM − 4 strike/ATM + 4 strike/ATM + 7 strike |
| 4 | 4 | ATM − 8 strike/ATM − 4 strike/ATM + 4 strike/ATM + 8 strike |

In a further embodiment, for financial instruments that are included in a strategy candidates set, strategy module 1016 generates a volatility index. A volatility index is a mathematical value indicating how much the price for a financial instrument is expected to fluctuate in the future. For example, volatility index for options increases when buying put options increases. Also, low values for volatility index indicate that an option is bearish, while the high values for volatility index indicate that the option is bullish.

In an embodiment, to calculate volatility index for an option, strategy module 1016 first generates a series volatility for the option. Example pseudo-code for generating series volatility is replicated below.

Retrieve Today's date;

Front series is 1st standard expiration;

Back series is 2nd standard expiration;

Front Days to Expire=Front Expiration−Today;

Back Days to Expire=Back Expiration−Today;

Front Minutes=Front Days*24*60;

Back Minutes=Back Days*24*60;

Front Minutes/Year=Front Minutes/525,600;

Back Minutes/Year=Back Minutes/525,600;
where a year has=525,600 minutes, and a month has 43,200 minutes;

FCS=Front ATM Call Strike;

FPS=Front ATM Put Strike;

Price Weight=(Last price−FCS)/(FPS−FCS)

FCV=Front ATM Call Implied Volatility;

FPV=Front ATM Put Implied Volatility;

Front Volatility=FPV*(1.0−Price Weight);

The preceding six steps may also be used to calculate the Back Volatility;

1^{st} Term=Front Minutes/Year*(Front Volatilitŷ2);

2^{nd} term=(Back Minutes−Minutes in month)/(Back Minutes−Front Minutes);

3^{rd} term=Back Minutes/Year*(Back Volatilitŷ2);

4^{th} term=(Minutes in month−Front Minutes)/(Back Minutes−Front Minutes);

5^{th} term=Minutes in Year/Minutes in Month;

Series Volatility=100*SQRT(((1^{st} Term*2^{nd} Term)+(3^{rd} Term*4^{th} Term))*5^{th} Term);

In an embodiment, market data database 214 includes market data used to calculate the series volatility for a financial instrument, such as the last price of the security, the ATM call and put implied volatilities, the ATM call strike price, the ATM put strike price, etc. The strategy module 1016 may use database interface 1022 to retrieve the required market data from market data database 214.

Further, the above example embodiment for determining the series volatility is not limiting and other embodiments for determining volatility of the financial instruments may be used.

In an embodiment, once strategy module 1016 generates the series volatility, strategy module 1016 generates the volatility index from the one or more series volatilities. Example pseudo-code for generating the index volatility from two series volatilities is replicated below:

t1=millisToFirstSeries/MILLIS_IN_YEAR;

t2=millisToSecondSeries/MILLIS_IN_YEAR;

vol1=firstSeriesVolatility;

vol2=secondSeriesVolatility;

tdays=DAYS_TO_CALCULATE/DAYS_IN_YEAR;

multiplier1=t1*(t2−tdays)/(t2−t1);

mulliplier2=t2*(tdays−t1)/(t2−t1);

volatilityIndex=sqrt((vol1*vol1*multiplier1+vol2*vol2*multiplier2)/tdays);

In an embodiment, the volatility index may indicate the volatility of the market and whether the market will move in the direction that makes a strategy profitable.

In a further embodiment, strategy module 1016 generates one or more break even points for each strategy candidate. A break even point is a price a financial instrument must reach for the investor of the financial instrument to avoid loss. In an embodiment, strategy module 1016 generates a break even point for each leg of strategy candidate. The break even point calculations depend on strategy type. For strategies that include a single option, strategy module 1016 generates a break even point as shown in Table 4, below:

TABLE 4

| Strategy Type | Break Even Point |
|---|---|
| Long Call | Strike(Long Call) + Ask(Long Call) |
| Long Put | Strike(Long Put) − Ask(Long Put) |
| Short Call | Strike(Short Call) + Bid(Short Call) |
| Short Put | Strike(Short Put) − Bid(Short Put) |
| Covered Call | Stock(Last) − Bid(Covered Call) |
| Cash Cov Put | Stock(Last) + Ask(Protected Put) |
| Bull Call | Lower Strike + Price(Bull Call) |
| Bear Call | Lower Strike + Price(Bear Call) |
| Bull Put | Higher Strike + Price(Bull Put) |
| Bear Put | Higher Strike − Price(Bear Put) |

In a further embodiment, for strategy candidates that include calendar and/or diagonal options, strategy module 1016 also generates a break even point depending on the strategy type. First, strategy module 1016 derives one or more variables necessary for calculating the break even point as shown below in Table 5:

TABLE 5

| Variables | Description | Definition |
|---|---|---|
| S | Spot Price of Underlying Stock | Input |
| X | Strike Price | Input |
| tB | 3 month T-Bill yield | Input |
| r | Risk Free Rate | Ln(1 + tB/100 * 91/365)/ |
| | | (91/365) |
| q | Dividend Yield | Input |
| tNear | Expiry Days for Near-Maturity | Near Expiry Date − |
| | Option | Today Date |
| tFar | Expiry Days for Far-Maturity | Far Expiry Date − Today |
| | Option | Date |
| tDays | Time between expiries in days | tFar − tNear |
| t | Time between expiries/year | (tfar − tNear)/365 |
| Sig | Volatility of underlying stock | Input |
| pNear | Near Premium (Average of Bid & | (Bid + Ask)/2 or Mark |
| | Ask or use Mark) | |
| pFar | Far Premium (Average of Bid & | (Bid + Ask)/2 or Mark |
| | Ask or use Mark) | |
| s2Near | Volatility for Near | (Sig \hat{ } 2) * pNear |
| s2Far | Volatility for Far | (Sig \hat{ } 2) * pFar |
| Vol | Forward Volatility | Sqrt((s2Far − s2Near)/ |
| | | tDays) |
| tDays | Time between expiries in days | tFar − tNear |

In an embodiment, strategy module 1016 retrieves the spot price of the underlying stock, the strike price, the 3 month T-Bill yield for security 1004, and other variables that require input from market data database 214.

In an embodiment, strategy module 1016 uses the one or more variables in Table 4 to generate two break even points, a lower break even point and an upper break even point. In a further embodiment, strategy module may use the Barone-Adese and Whaley Model or Black-Sholes model to determine the lower break even point and the upper break even point using the one or more variables. These models are known to a person of ordinary skill in the art. For example, strategy module 1016 may use the underlying price Si (where i is an integer), and price Si may be initialized to strike price X of Table 4 for calendar options or strike price nX of diagonal options. Strategy manager 1016 then increments or decrements the strike price X or nX according to the pseudo-code below:

Using Si in a loop:

Calculate the theoretical option price pTheo for Si for calendar options or pTheo(Si,fX) for diagonal options using one of the Barone-Adese and Whaley, or Black-Sholes models;

Calculate the corresponding derivative using one of the models above, for incrementing Si as described below;

Perform a profit calculation as follows:
Calendar Call:
   Profit=pNear−(Si−X, or 0 if negative)+pTheo−pFar;
Calendar Put:
   Profit=pNear−(X−Si, or 0 if negative)+pTheo−pFar;
Diagonal Call:
   Profit=pNear−(Si−nX, or 0 if negative)+pTheo(Si,fX)−pFar;
Diagonal Put:
   Profit=pNear−(nX−Si, or 0 if negative)+pTheo(Si,fX)−pFar;

Determine if the Profit approaches zero, using, for example, Abs(Profit−0)<0.000001.

If the Profit does not approach zero, adjust call options as follows:

Si=Si−Profit/Derivative;

and the put options as follows:

Si=Si+Profit/Derivative

If the Profit approaches zero, terminate the loop and return the Si as the break even point (BE) for that region of the option.

In a further embodiment, for strategy candidates having three and/or four legs, strategy module 1016 generates two break even points, break even one and break even two, as shown below in Table 6, below:

TABLE 6

| Strategy | Break Even Point One | Break Even Point Two |
|---|---|---|
| Long Straddle | Strike − Ask(Leg1) − | Strike + Ask(Leg1) + |
| | Ask(Leg2) | Ask(Leg2) |
| Long Strangle | Lower Strike − | Higher Strike + |
| | Ask(Leg1) − Ask(Leg2) | Ask(Leg1) + Ask(Leg2) |
| Short Straddle | Strike − Ask(Leg1) − | Strike + Ask(Leg1) + |
| | Ask(Leg2) | Ask(Leg2) |
| Short Strangle | Lower Strike − | Higher Strike + |
| | Ask(Leg1) − Ask(Leg2) | Ask(Leg1) + Ask(Leg2) |
| Long Call | Strike(leg1) + Price(Long | Strike(leg3) − Price(Long |
| Butterfly | Call Butterfly) | Call Butterfly) |
| Long Put | Strike(leg1) + Price(Long | Strike(leg3) − Price(Long |
| Butterfly | Put Butterfly) | Put Butterfly) |
| Long Call | Strike(leg1) + Price(Long | Strike(leg4) − Price(Long |
| Condor | Call Condor) | Call Condor) |
| Long Put | Strike(leg1) + Price(Long | Strike(leg4) − Price(Long |
| Condor | Put Condor) | Put Condor) |
| Long Iron | Strike(leg 1) + Price(Long | Strike(leg3) − Price(Long |
| Butterfly | Iron Butterfly) | Iron Butterfly) |
| Long Iron | Strike(leg1) + Price(Long | Strike(leg3) − Price(Long |
| Condor | Iron Condor) | Iron Condor) |
| Short Call | Strike(leg1) + | Strike(leg3) − |
| Butterfly | abs(Price(Short Call | abs(Price(Short Call |
| | Butterfly)) | Butterfly)) |
| Short Put | Strike(leg1) + | Strike(leg3) − |
| Butterfly | abs(Price(Short Put | abs(Price(Short Put |
| | Butterfly)) | Butterfly)) |
| Short Call | Strike(leg1) + | Strike(leg4) − |
| Condor | abs(Price(Short Call | abs(Price(Short Call |
| | Condor)) | Condor)) |
| Short Put | Strike(leg1) + | Strike(leg4) − |
| Condor | abs(Price(Short Put | abs(Price(Short Put |
| | Condor)) | Condor)) |
| Short Iron | Strike(leg1) + | Strike(leg3) − |
| Butterfly | abs(Price(Short Iron | abs(Price(Short Iron |
| | Butterfly)) | Butterfly)) |
| Short Iron | Strike(leg1) + | Strike(leg3) − |
| Condor | abs(Price(Short Iron | abs(Price(Short Iron |
| | Condor)) | Condor)) |

In an embodiment, strategy module 1016 also determines a maximum profit and maximum loss values for each strategy candidate. Strategy module 1016 may determine the maximum profit and maximum loss values based on strategy type. For example, for strategy candidates having a single option, strategy module 1016 determines the maximum profit and loss as shown in Table 7, below:

TABLE 7

| Strategy Type | Maximum Profit | Maximum Loss |
|---|---|---|
| Long Call | Infinity | Ask (Long Call) * 100 |
| Long Put | Infinity | Ask (Long Put) * 100 |
| Short Call | Bid (Short Call) * 100 | Infinity |
| Short Put | Bid (Short Put) * 100 | (Strike Price − Bid (Short |
| | | Put)) * 100 |

In an embodiment, for strategy candidates having a single option and a stock, strategy module 1016 determines the maximum profit and loss as shown in Table 8, below:

TABLE 8

| Strategy Type | Maximum Profit | Maximum Loss |
|---|---|---|
| Covered Call | Strike − Stock(Last) + | Stock price − Bid(Long |
| | Bid(Covered Call)) * 100 | Call) * 100 |
| Cash Covered Put | Infinity | (Stock − Strike + |
| | | Ask(Protected Put)) * 100 |

In an embodiment, for strategy candidates having two options, including vertical strategies, calendar strategies, diagonal strategies, and straddle/strangle strategies, strategy module 1016 determines the maximum loss by first determining a price for the strategy, as shown in Table 9, below:

TABLE 9

| Strategy Type | Price |
|---|---|
| Call Calendar | Leg1 Ask − Leg2 Bid |
| Put Calendar | Leg1 Ask − Leg2 Bid |
| Diagonal Call Calendar | Leg1 Ask − Leg2 Bid |
| Diagonal Put Calendar | Leg1 Ask − Leg2 Bid |
| Long Straddle | Leg1 Ask + Leg 2 Ask |
| Long Strangle | Leg1 Ask + Leg 2 Ask |
| Short Straddle | Leg 1 Bid + Leg 2 Bid |
| Short Strangle | Leg 1 Bid + Leg 2 Bid |

Once strategy module 1016 determines the price for the various strategy types above, strategy module 1016 uses the price to determine the maximum loss for the strategy candidates, as shown in Table 10, below:

TABLE 10

| Strategy Type | Maximum loss |
|---|---|
| Bull Call | Price(Bull Call) * 100 |
| Bear Call | (Highest Strike − Lowest Strike − |
| | Price(Bear Call)) * 100 |
| Bull Put | (Highest Strike − Lowest Strike + |
| | Price(Bull Put)) * 100 |
| Bear Put | Price(Bear Put) * 100 |
| Call Calendar | Price(Calendar Call) * 100 |
| Put Calendar | Price(Calendar Put) * 100 |
| Diagonal Call Calendar | Price(Diagonal Call) * 100 |
| Diagonal Put Calendar | Price(Diagonal Put) * 100 |
| Long Straddle | Price(Long Straddle) * 100 |
| Long Strangle | Price(Long Strangle) * 100 |
| Short Straddle | Infinity |
| Short Strangle | Infinity |

In a further embodiment, for the strategy candidates where the maximum loss may be infinite, strategy module 1016 determines an estimate of the maximum loss of a stock price as follows:

Estimate of the maximum loss of stock price=Stock Price (Last)*(1+(3*Std. Dev.)).

In a further embodiment, strategy module 1016 uses a Black Sholes method to estimate the stock price for a strategy. The Black Sholes method is known to a person of ordinary skill in the art.

From the estimate of the maximum loss of a stock price, strategy module 1016 determines an estimate of the maximum loss for each strategy candidate as follows:

Estimate maximum loss for a strategy=A theoretical price of a strategy (Estimate of the maximum loss of stock price)*100.

In an embodiment, strategy module 1016 determines the maximum profit for strategy candidates having two legs, as shown using the pseudo-code below:

If the legs on each side of the strategy candidate are equal:
If the spread is a credit, the maximum profit=credit*quantity*multiplier (100);
If the spread is a debit, the maximum profit=(spread width−credit)*quantity*multiplier (100);

If the legs on each side of the strategy candidate are not equal:
If the spread is a credit, the maximum profit=credit*quantity*multiplier (100);
If the spread is a debit, the maximum profit may be infinite.

In an embodiment, for strategy candidates having three or four options, strategy module 1016 determines the maximum profit and maximum loss as shown in Table 11, below:

TABLE 11

| Strategy Type | Maximum Profit | Maximum Loss |
|---|---|---|
| Long Call | ((Strike(leg2) − | Price(Long Call Butterfly) |
| Butterfly | Strike(Leg1)) − Price(Long | |
| | Call Butterfly) | |
| Long Put | ((Strike(leg2) − | Price(Long Put Butterfly) |
| Butterfly | Strike(Leg1)) − Price(Long | |
| | Put Butterfly) | |
| Long Call | ((Strike(leg2) − | Price(Long Call Condor) |
| Condor | Strike(Leg1)) − Price(Long | |
| | Call Condor) | |
| Long Put | ((Strike(leg2) − | Price(Long Put Condor) |
| Condor | Strike(Leg1)) − Price(Long | |
| | Put Condor) | |
| Long Iron | Price(Long Iron Butterfly) | ((Strike(leg2) − |
| Butterfly | | Strike(Leg1)) − Price(Long |
| | | Iron Butterfly) |
| Long Iron | Price(Long Iron Condor) | ((Strike(leg2) − |
| Condor | | Strike(Leg1)) + Price(Long |
| | | Iron Butterfly) |
| Short Call | Price(Short Call Butterfly) | ((Strike(leg2) − |
| Butterfly | Credit | Strike(Leg1)) + Price(Short |
| | | Call Butterfly) |
| Short Put | Price(Short Put Butterfly) | ((Strike(leg2) − |
| Butterfly | Credit | Strike(Leg1)) + Price(Short |
| | | Put Butterfly) |
| Short Call | Price(Short Call Condor) | ((Strike(leg2) − |
| Condor | Credit | Strike(Leg1)) + Price(Short |
| | | Call Condor) |
| Short Put | Price(Short Put Condor) | ((Strike(leg2) − |
| Condor | Credit | Strike(Leg1)) + Price(Short |
| | | Put Condor) |
| Short Iron | ((Strike(leg2) − | Price(Short Iron Butterfly) |
| Butterfly | Strike(Leg1)) − | Credit |
| | abs(Price(Short Iron | |
| | Butterfly)) | |
| Short Iron | ((Strike(leg2) − | Price(Short Call Condor) |
| Condor | Strike(Leg1)) − Price(Short | Credit |
| | Iron Condor) | |

In an embodiment, once strategy module 1016 generates a strategy candidate set, and determines the maximum profit, maximum loss, break even points, etc., for each strategy candidate, risk module 1018 and allocation module 1020 also reduce the strategy candidate set.

In an embodiment, allocation module 1020 determines whether the maximum loss associated with each strategy candidate is greater than allocation 1012. If the maximum loss of the strategy candidate is greater than allocation 1012, allocation module 1020 discards the strategy candidate. In a further embodiment, allocation module 1020 determines whether the strategy candidate may be discarded according to the pseudo code below:

Quantity=1 (as a basis);

Quantity Multiplier=round up (Minimum Allocation Amount/Strategy Max Loss);

If (Quantity*Quantity Multiplier)>Firm Max Contracts;
Cap Multiplier to Firm Max Contracts;

If (Strategy Max Loss*Quantity*Quantity Multiplier)<to Maximum Allocation Amount;
Keep Strategy in the Strategy Candidates Set;

Else
Exclude Strategy from the Strategy Candidates Set;

In an embodiment, the Firm Max Contracts is a maximum number of option contracts that are available for a strategy candidate, and may be retrieved from market data database 214.

In a further embodiment, where allocation 1012 includes a minimum and maximum values, allocation module 1016 excludes the strategy candidate when the maximum loss of the strategy is outside of the minimum and maximum values.

In an embodiment, risk module 1018 also reduces the strategy candidate set based on probability of success 1010.

In an embodiment, to determine the probability of success for each strategy candidate in the strategy candidate set, risk module 1018 determines the probability of success at an underlying price P. To determine the probability at price P, risk module 1018 uses the volatility index for each strategy candidate that was determined as described above. In an embodiment, risk module 1018 determines probability for price P using market conditions for a security, such as, the volatility index, interest rate, yield, current price, and days to expiration as inputs, according to the pseudo code below:

x=log(P/currentPrice);

v=interestRate−yield−0.5*volatility Index*volatility Index;

years=days_to_expiration/DAYS_IN_YEAR;

volcorrect=volatility Index*sqrt(years);

ProbAtPrice(P)=(x−v*years)/volcorrect;

The interest rate, yield, current price data may also be retrieved from market data database 214.

In an embodiment, risk module 1018 determines probability of success using the volatility index and the one or more break even points determined above. For example, given the volatility index, the interest rate, the yield, the current price, the days to expiration and the break even point (for a single leg strategy) or the low and high break even points (for the multi-leg strategy) as inputs, risk module 1018 determines probability of success for a strategy candidate using the pseudo code below:

Calculate probability of break even point (BE) delimited Price segments:

Initial probability of success=0;

If Strategy has 1 break even point (BE);
Set probability of success=probAtPrice(BE);

If Strategy has 2 break even points (BEs):
If region from 0 to lowBE price is positive P/L:
   Add to probability of success: (1−probAtPrice(lowBE));
If region from 1st BE to 2nd BE price is positive P/L:
   Add to probability of success: abs((probAtPrice(highBE)−probAtPrice(lowBE)));
If region from 2^{nd} BE price to infinity is positive P/L
   Add to probability of success: (1−probAtPrice(highBE));

Return probability of success.

In an embodiment, once risk module 1018 determines the probability of success, risk module compares the determined probability of success to probability of success 1010 received using strategy criteria 210. When the probability of success determined using risk module 1018 is less than probability of success 1010, risk module 1018 discards the strategy candidate from the strategy candidate set. In a further embodiment, when probability of success 1010 includes a range of probability values, risk module 1018 discards the strategy candidate from the strategy candidate set that has the determined probability of success outside of the range of probability values.

In an embodiment, when market data module 1014, strategy module 1016, risk module 1018, and allocation module 1020 exclude strategies candidates from the strategy candidate set that do not comply with strategy criteria 210, strategy generator 212 generates strategy list 216. Strategy list 216 includes strategies remaining in the strategy candidate set, and transmits strategy list 216 to client 104, where client 104 displays strategy list 216 as discussed in FIGS. 3A-D, etc.

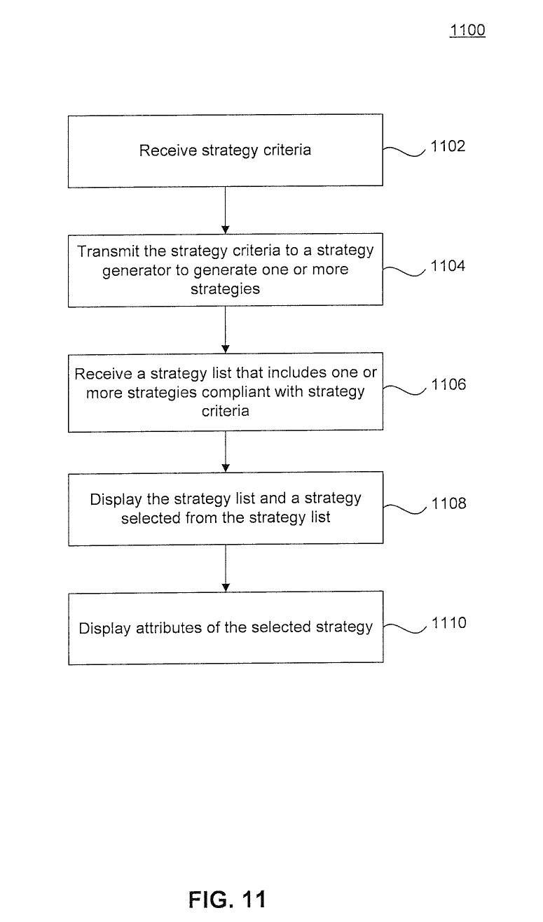

FIG. 11 is a flow chart of a method 1100 for displaying a strategy and a strategy list, according to an embodiment.

At operation 1102, strategy criteria is received. For example, user interface 202 receives input that selects criteria for a strategy from different categories, such as, direction 310, timing 312, probability of success 314 and allocation 316. The selected criteria are collectively referred to as strategy criteria 210.

At operation 1104, the strategy criteria is transmitted to a strategy generator. For example, client 104 transmits strategy criteria 210 to strategy generator 112, where strategy generator 112 generates strategy list 216 based on the strategy criteria 210.

At operation 1106, a strategy list is received. For example, client 104 receives strategy list 216. Strategy list 216 includes one or more strategies compliant with strategy criteria 210.

At operation 1108, a strategy list and a strategy are displayed. For example, graphical representation interface 330 displays strategy 326 from strategy list 216, and attribute display 328 displays attributes, such as, probability of success 334, maximum profit 336, maximum loss 338 and days to expiration 340 associated with strategy 326. In a further example, strategy list display 322 displays strategy list 216.

At operation 1110, attributes of a strategy are displayed. For example, when one of the attributes of strategy 326 is selected, strategy 326 and the selected attribute are displayed using graphical representation interface 330.

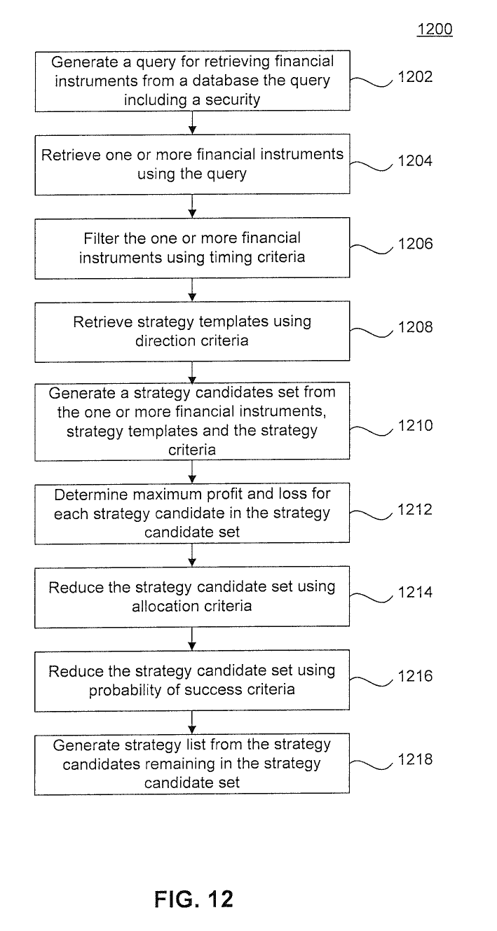

FIG. 12 is a flow chart of a method 1200 for generating a strategy and a strategy list, according to an embodiment.

At operation 1202, a query is generated. For example, a query including security 1004 is generated. The query is submitted to market data database 214.

At operation 1204, one or more financial instruments are retrieved. For example, using the query and database interface 1022, market data module 1014 retrieves one or more financial instruments associated with security 1004 from market data database 214.

At operation 1206, one or more financial instruments are filtered according to a timing criteria. For example, market data module 1014 excludes the one or more financial instruments having an expiration date outside of the date included in timing 1008.

At operation 1208, strategy templates are selected based on the direction criteria. For example, strategy module 1016 retrieves strategy templates 1028 from strategy storage 1026. In an embodiment, strategy module 1016 retrieves strategy templates 1028 based on direction 1006.

At operation 1210, a strategy candidate set is generated. For example, strategy module 1016 generates one or more strategy candidates using strategy templates and one or more financial instruments. In an embodiment, each strategy candidate corresponds to a type of a strategy template and includes one or more financial instruments as specified by the strategy template.

At operation 1212, a maximum profit and maximum loss are determined. For example, strategy module 1016 determines a maximum profit and maximum loss for each strategy candidate. In a further embodiment, strategy module 1016 determines maximum profit and maximum loss according to a strategy type.

At operation 1214, a strategy candidate set is reduced according to allocation criteria. For example, allocation module 1020 excludes one or more strategy candidates from the strategy candidate set when the maximum loss from the one or more strategy candidates exceeds allocation 1012. In another example, allocation module 1020 excludes the one or more strategy candidates when the maximum loss for the strategy candidate falls outside of the minimum and maximum allocation range included in allocation 1012.

At operation 1216, a strategy candidate set is reduced using a probability of success criteria. For example, risk module 1018 determines the probability of success for each strategy candidate. In a further embodiment, probability of success may be based on strategy type. Further, risk module 1018 may exclude a strategy candidate from the strategy candidate set when the determined probability of success is less than probability of success 1010.

At operation 1218, a strategy list is generated. For example, strategy generator 212 generates strategy list 216 from strategy candidates remaining in the strategy candidate set. Once generated, strategy generator 212 transmits strategy list 216 to client 104.

### Example Computer System

Various embodiments can be implemented, for example, using one or more well-known computer systems, such as computer system 1300 shown in FIG. 13. Computer system 1300 can be any well-known computer capable of performing the functions described herein, such as computers available from International Business Machines, Apple, Sun, HP, Dell, Sony, Toshiba, etc.

Computer system 1300 includes one or more processors (also called central processing units, or CPUs), such as a processor 1304. Processor 1304 is connected to a communication infrastructure or bus 1306.

Computer system 1300 also includes user input/output device(s) 1303, such as monitors, keyboards, pointing devices, etc., which communicate with communication infrastructure 1306 through user input/output interface(s) 1302.

Computer system 1300 also includes a main or primary memory 1308, such as random access memory (RAM). Main memory 1308 may include one or more levels of cache. Main memory 1308 has stored therein control logic (i.e., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 518. Removable storage unit 1318 includes a computer usable or readable storage device having stored thereon computer software (control logic) and/or data. Removable storage unit 1318 may be a floppy disk, magnetic tape, compact disk, DVD, optical storage disk, and/any other computer data storage device. Removable storage drive 1314 reads from and/or writes to removable storage unit 1318 in a well-known manner.

According to an exemplary embodiment, secondary memory 1310 may include other means, instrumentalities or other approaches for allowing computer programs and/or other instructions and/or data to be accessed by computer system 1300. Such means, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1300 may further include a communication or network interface 1324. Communication interface 1324 enables computer system 1300 to communicate and interact with any combination of remote devices, remote networks, remote entities, etc. (individually and collectively referenced by reference number 1328). For example, communication interface 1324 may allow computer system 1300 to communicate with remote devices 1328 over communications path 1326, which may be wired and/or wireless, and which may include any combination of LANs, WANs, the Internet, etc. Control logic and/or data may be transmitted to and from computer system 1300 via communication path 1326.

In an embodiment, a tangible apparatus or article of manufacture comprising a tangible computer useable or readable medium having control logic (software) stored thereon is also referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as system 1300), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 13. In particular, embodiments may operate with software, hardware, and/or operating system implementations other than those described herein.

### CONCLUSION

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A system comprising:
a specialized database configured to store real-time data, and further configured to retrieve a plurality of financial instruments associated with a security;
a strategy generator configured to:
retrieve at least one strategy template from a memory storage based on direction criteria, wherein the direction criteria is a prediction of a future stock price of the security;
generate a strategy list using the at least one strategy template and the plurality of financial instruments, wherein the at least one strategy template indicates a number and type of financial instruments that comprise at least one strategy corresponding to the at least one strategy template and wherein the at least one strategy is compliant with strategy criteria; and
transmit the strategy list for display to a client device over a network, whereby a graphical representation of the at least one strategy and an attribute associated with the at least one strategy that can be traded using the real-time data are displayed on the client device.

2. The system of claim 1, wherein the strategy criteria includes timing criteria, and the strategy generator is further configured to remove a financial instrument from the plurality of financial instruments having an expiration date outside of the timing criteria.

3. The system of claim 1, wherein the strategy generator is further configured to determine a maximum profit and a maximum loss for the at least one strategy in the strategy list.

4. The system of claim 3, wherein the strategy criteria includes an allocation criteria indicating a monetary amount that can be allocated to the at least one strategy; and
the strategy generator is further configured to remove the at least one strategy from the strategy list when the maximum loss exceeds the allocation criteria.

5. The system of claim 3, wherein the strategy generator is further configured to determine the maximum profit and the maximum loss based on a strategy type and price of the at least one strategy.

6. The system of claim 1, wherein the strategy generator is further configured to:
determine a probability of success for the at least one strategy in the strategy list, wherein the probability of success is probability that the at least one strategy becomes profitable; and
remove the at least one strategy from the strategy list when the determined probability of success is less than a probability of success criteria included in the strategy criteria.

7. The system of claim 6, wherein the probability of success for the at least one strategy is based on at least a current price of a stock of a security, a volatility index and a break even point associated with the at least one strategy.

8. The system of claim 1, wherein a first financial instrument in the plurality of financial instruments is an option and a second financial instrument in the plurality of the financial instruments is a stock.

9. The system of claim 1, wherein the database is further configured to:
receive a query, wherein the query includes the strategy criteria; and
retrieve the plurality of financial instruments in response to the query.

10. The system of claim 1, further comprising an application executing on the client device, wherein the application includes a user interface configured to receive a selection for the strategy criteria.

11. The system of claim 1, wherein the strategy criteria includes at least one of a direction criteria, timing criteria, probability of success criteria and allocation criteria.

12. The system of claim 1, further comprising an application executing on the client device, wherein the application includes a user interface configured to:
display a graphical representation of the at least one strategy in the strategy list;
display a plurality of attributes associated with the at least one strategy; and
modify the graphical representation of the at least one strategy based on a selection of an attribute from the plurality of attributes.

13. A method, comprising:
retrieving, from a database configured to store real-time data, a plurality of financial instruments associated with a security;
retrieving a strategy template from a memory storage based on a direction criteria, wherein the direction criteria predicts a future price direction for the security;
generating a strategy list using the strategy template and the plurality of financial instruments, wherein the strategy list includes a strategy and the strategy template indicates a number and type of financial instruments that comprise the strategy;
comparing the strategy to strategy criteria; and
transmitting the strategy list for display to a client device when the strategy conforms to the strategy criteria, whereby a graphical representation of the strategy and an attribute associated with the strategy that can be traded using the real-time data are displayed on the client device.

14. The method of claim 13, wherein the strategy criteria includes allocation criteria, wherein the allocation criteria indicates a portion of a portfolio allocated for trading the strategy;
determining a maximum loss for the strategy in the strategy list; and
removing the strategy from the strategy list when the maximum loss exceeds the allocation criteria.

15. The method of claim 14, further comprising:
determining the maximum loss based on a strategy type and price of the strategy.

16. The method of claim 13, further comprising:
determining probability of success for the strategy in the strategy list based on at least a current price of a stock of a security, a volatility index and a break even point; and
removing the strategy from the strategy list when the probability of success for the strategy is less than a probability of success criteria.

17. The method of claim 13, wherein a first financial instrument in the plurality of financial instruments is an option and a second financial instrument in the plurality of the financial instruments is a stock.

18. A system comprising:
an application executing on a client device and configured to:
generate strategy criteria from a plurality of selected inputs; and
display a graphical representation of the strategy and at least one attribute associated with the strategy; and
a strategy server configured to:
generate a strategy based on the strategy criteria, wherein the strategy is a combination of one or more financial instruments, wherein the one or more financial instruments include an option;
generate the at least one attribute associated with the strategy, wherein the at least one attribute indicates performance of the strategy and wherein the at least attribute is compliant with the strategy criteria; and
transmit the strategy to the application executing on the client device, wherein the application is operable to trade the strategy using real-time data.

19. The system of claim 18, wherein the application is further configured to display a video stream describing the strategy and the at least one attribute.

20. The system of claim 18, wherein the application is further configured to receive an input to trade the strategy.
